(19) United States
(12) Patent Application Publication
(10) Pub. No.: US 2025/0191032 A1
(43) Pub. Date: Jun. 12, 2025

(54) INFORMATION PROCESSING APPARATUS, INFORMATION PROCESSING METHOD, AND RECORDING MEDIUM

(71) Applicant: Sony Group Corporation, Tokyo (JP)

(72) Inventors: Maho HAYASHI, Tokyo (JP); Yuya TAKAYAMA, Tokyo (JP); Tetsuo IKEDA, Tokyo (JP); Seishi TOMONAGA, Tokyo (JP); Yasuhiro YUKAWA, Tokyo (JP)

(73) Assignee: Sony Group Corporation, Tokyo (JP)

(21) Appl. No.: 18/844,092

(22) PCT Filed: Feb. 27, 2023
(86) PCT No.: PCT/JP2023/006963

§ 371 Date: Sep. 5, 2024

(30) Foreign Application Priority Data
Mar. 16, 2022 (JP) 2022-040935

(51) Int. Cl. G06Q 30/0272; G06Q 30/0251

(52) U.S. Cl. CPC G06Q 30/0272; G06Q 30/0255; G06Q 30/0266

(57) ABSTRACT

The present technology relates to an information processing apparatus, an information processing method, and a recording medium capable of accurately measuring the effectiveness of advertisements.

The information processing apparatus of the present technology includes an effectiveness measurement unit configured to measure effectiveness of an advertisement on the basis of encounter timing at which a user has encountered the advertisement and consumption timing at which the user has taken consumption behavior for an advertisement target of the advertisement. The effectiveness measurement unit measures the effectiveness of the advertisement on the basis of an evaluation value calculated using a weight corresponding to required consumption time from the encounter timing to the consumption timing. The present technology can be applied to servers configured to measure the effectiveness of the advertisements presented by vehicles, for example.

### TECHNICAL FIELD

The present technology relates to an information processing apparatus, an information processing method, and a recording medium, and in particular, to an information processing apparatus, an information processing method, and a recording medium capable of accurately measuring the effectiveness of advertisements.

### BACKGROUND ART

Vehicles such as trucks are utilized as advertisement display media. Advertisements have the effect of stimulating the consumption behavior of consumers such as pedestrians and drivers of other vehicles.

The effectiveness of advertisements is measured on the basis of, for example, the gaze degrees of drivers for the advertisements and the relevance degree of the consumption behavior of the drivers (for example, see PTL 1).

### CITATION LIST

### Patent Literature

### [PTL 1]

Japanese Patent Laid-open No. 2021-36366

### SUMMARY

### Technical Problem

In general, consumers are considered not to take consumption behavior at the timing at which they are seeing advertisements in cities, but to take consumption behavior at the timing after time has elapsed since they have seen the advertisements, such as after returning home. In the technology described in PTL 1, the time difference between when a consumer sees an advertisement and when he/she takes consumption behavior is not reflected in the measurement of the effectiveness of the advertisement, and hence the measurement accuracy of the effectiveness of the advertisement is possibly low.

The present technology has been made in view of such circumstances and aims to make it possible to accurately measure the effectiveness of advertisements.

### Solution to Problem

An information processing apparatus according to an aspect of the present technology includes an effectiveness measurement unit configured to measure effectiveness of an advertisement on the basis of encounter timing at which a user has encountered the advertisement and consumption timing at which the user has taken consumption behavior for an advertisement target of the advertisement.

An information processing method according to an aspect of the present technology includes calculating, by an information processing apparatus, an evaluation value of an advertisement on the basis of encounter timing at which a user has encountered the advertisement and consumption timing at which the user has taken consumption behavior for an advertisement target of the advertisement.

A recording medium according to an aspect of the present technology records a program for executing processing of calculating an evaluation value of an advertisement on the basis of encounter timing at which a user has encountered the advertisement and consumption timing at which the user has taken consumption behavior for an advertisement target of the advertisement.

In an aspect of the present technology, an evaluation value of an advertisement is calculated on the basis of encounter timing at which a user has encountered the advertisement and consumption timing at which the user has taken consumption behavior for an advertisement target of the advertisement.

### BRIEF DESCRIPTION OF DRAWINGS

FIG. 1 is a diagram illustrating a configuration example of an advertisement evaluation system according to an embodiment of the present technology.

FIG. 2 is a block diagram illustrating configuration examples of an advertiser terminal and an advertising agency server.

FIG. 3 is a diagram illustrating an example of advertisement information.

FIG. 4 is a block diagram illustrating a configuration example of an advertisement presentation vehicle.

FIG. 5 is a diagram illustrating an example of vehicle information.

FIG. 6 is a block diagram illustrating a configuration example of a personal terminal.

FIG. 7 is a diagram illustrating an example of consumer information.

FIG. 8 is a block diagram illustrating a configuration example of an advertisement effectiveness measurement server.

FIG. 9 is a diagram illustrating an example of a calculation method for gaze degrees.

FIG. 10 is a diagram illustrating examples of consumption stages based on the AISAS model.

FIG. 11 is a diagram illustrating an example of a determination method for consumption stages depending on evaluation systems.

FIG. 12 is a diagram illustrating examples of predicted consumption time depending on the categories of advertisement targets.

FIG. 13 depicts diagrams illustrating examples of a weighted value depending on the difference between required consumption time and predicted consumption time.

FIG. 14 is a flowchart illustrating the processing performed by the advertisement effectiveness measurement server.

FIG. 15 is a flowchart illustrating evaluation system determination processing performed in Step S2 of

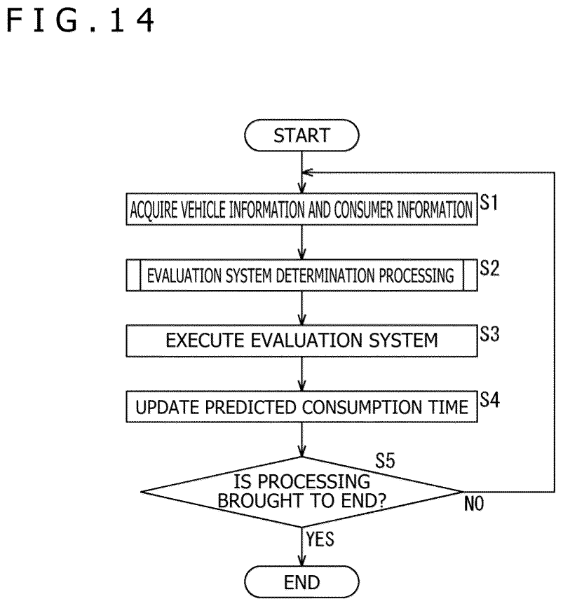

FIG. 14.

FIG. 16 is a diagram illustrating examples of screens displayed on an advertisement list application.

FIG. 17 illustrates the processing flow of a passive evaluation system.

FIG. 18 is a diagram illustrating examples of screens displayed on a search application.

FIG. 19 is a diagram illustrating examples of search keys.

FIG. 20 is a flowchart illustrating the processing flow of an active evaluation system.

FIG. 21 is a diagram illustrating an example of a determination method for consumption stages in a latent evaluation system.

FIG. 22 is a flowchart illustrating the processing flow of the latent evaluation system.

FIG. 23 is a diagram illustrating an example in which advertisement effectiveness analysis results are utilized.

FIG. 24 is a block diagram illustrating a configuration example of the advertisement effectiveness measurement server configured to analyze the effectiveness of advertisements.

FIG. 25 is a block diagram illustrating a configuration example of the advertiser terminal utilizing advertisement effectiveness analysis results.

FIG. 26 is a block diagram illustrating a configuration example of the advertisement presentation vehicle utilizing advertisement effectiveness analysis results.

FIG. 27 is a diagram illustrating examples of rewards depending on consumption stages.

FIG. 28 is a block diagram illustrating a configuration example of the advertising agency server configured to determine rewards depending on consumption stages.

FIG. 29 is a block diagram illustrating a configuration example of the advertisement presentation vehicle configured to receive rewards depending on consumption stages.

FIG. 30 is a block diagram illustrating a configuration example of the advertisement effectiveness measurement server configured to analyze causes for the consumption stages.

FIG. 31 is a diagram illustrating feedback content depending on consumer information.

FIG. 32 is a block diagram illustrating a configuration example of the advertiser terminal utilizing consumption stage analysis results.

FIG. 33 depicts diagrams illustrating examples of advertisements depending on consumer transportation methods.

FIG. 34 is a block diagram illustrating a configuration example of the advertisement effectiveness measurement server configured to determine consumer transportation methods.

FIG. 35 is a block diagram illustrating a configuration example of the advertisement presentation vehicle configured to change advertisements depending on consumer transportation methods.

FIG. 36 depicts diagrams illustrating examples of advertisements depending on map information regarding the surroundings of consumers.

FIG. 37 is a block diagram illustrating a configuration example of the advertisement presentation vehicle configured to change advertisements depending on map information regarding the surroundings of consumers.

FIG. 38 is a block diagram illustrating a configuration example of an outdoor advertising medium.

FIG. 39 is a block diagram illustrating a configuration example of the hardware of a computer.

### DESCRIPTION OF EMBODIMENT

Now, a mode for carrying out the present technology is described. The descriptions are given in the following order.
1. Configuration of Advertisement Evaluation System
2. Operation of Advertisement Effectiveness Measurement Server
3. Application Examples

### 1. Configuration of Advertisement Evaluation System

### —Entire Advertisement Evaluation System

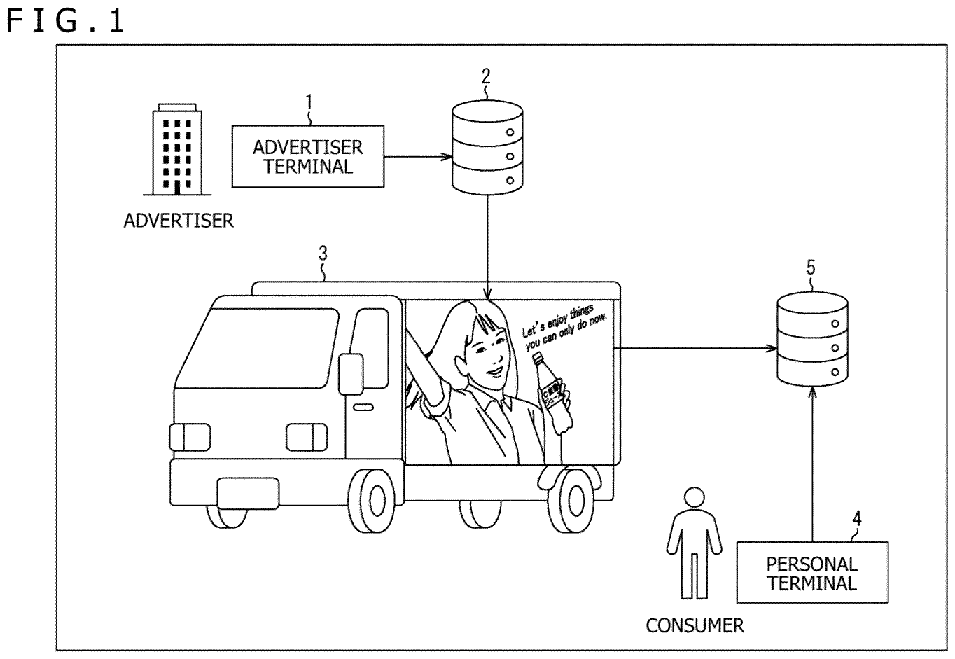

FIG. 1 is a diagram illustrating a configuration example of an advertisement evaluation system according to an embodiment of the present technology.

The advertisement evaluation system of FIG. 1 includes an advertiser terminal 1, an advertising agency server 2, an advertisement presentation vehicle 3, a personal terminal 4, and an advertisement effectiveness measurement server 5. The advertiser terminal 1, the advertising agency server 2, the advertisement presentation vehicle 3, the personal terminal 4, and the advertisement effectiveness measurement server 5 are connected to each other via a network, for example.

The advertiser terminal 1 includes a smartphone, a tablet terminal, a PC, or the like. A company that is an advertiser outsources the presentation of advertisements for promoting the use of products or services to another company that is an advertising agency and operates the advertiser terminal 1 to define advertisement information that is information regarding the advertisements. The advertiser terminal 1 transmits the advertisement information defined on the basis of the operations performed by the advertiser, to the advertising agency server 2.

The advertising agency server 2 is managed by the advertising agency. The advertising agency aggregates advertisements, the presentation of which has been outsourced by the advertiser, to the advertising agency server 2. The advertising agency server 2 distributes and transmits the advertisement information transmitted from the advertiser terminal 1 to each of the multiple advertisement presentation vehicles 3.

The advertisement presentation vehicle 3 includes a wrapped car, a truck, a taxi, or any other compact car provided with an advertising medium configured to present advertisements to consumers.

The advertisement presentation vehicle 3 displays, for example, advertisement images corresponding to the advertisement information transmitted from the advertising agency server 2 on a display serving as an advertising medium. In the example of FIG. 1, an advertisement for promoting the purchase of a beverage is displayed on a display provided on the side surface of the advertisement presentation vehicle 3.

The advertisement presentation vehicle 3 defines vehicle information indicating, for example, the history of location information regarding the advertisement presentation vehicle 3 having traveled while presenting advertisements, and transmits the vehicle information to the advertisement effectiveness measurement server 5.

The personal terminal 4 includes a digital device such as a smartphone, a tablet terminal, or a PC carried by a consumer who is a user. The consumer includes a pedestrian, a passenger of a vehicle other than the advertisement presentation vehicle 3, a cyclist, or the like.

The consumer sees an advertisement presented by the advertisement presentation vehicle 3 that he/she has encountered outside the home and takes consumption behavior such as purchasing the advertisement target of the advertisement after returning home, for example. The consumer can use, for example, the personal terminal 4 to view EC (Electronic Commerce) sites and purchase the advertisement target.

The personal terminal 4 defines consumer information indicating the history of location information regarding the consumer and the history of operation content on the personal terminal 4 and transmits the consumer information to the advertisement effectiveness measurement server 5.

The advertisement effectiveness measurement server 5 includes an information processing apparatus having functions of acquiring vehicle information and consumer information from the advertisement presentation vehicle 3 and the personal terminal 4, and of measuring the effectiveness of advertisements on the basis of the vehicle information and the consumer information.

### —Advertiser Terminal 1 and Advertising Agency Server 2

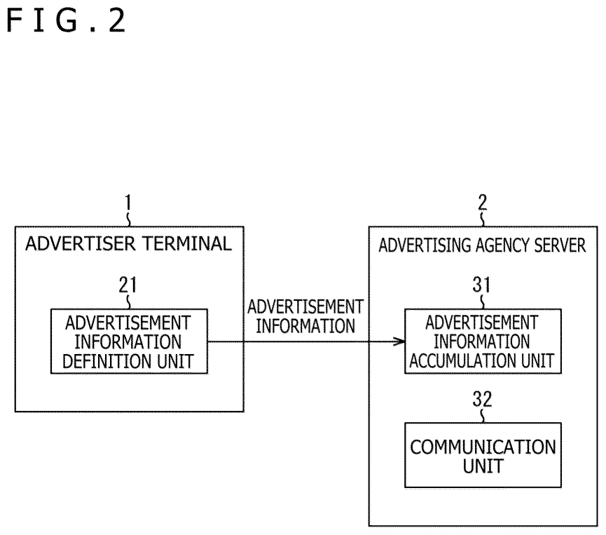

FIG. 2 is a block diagram illustrating configuration examples of the advertiser terminal 1 and the advertising agency server 2.

As illustrated in FIG. 2, the advertiser terminal 1 includes an advertisement information definition unit 21.

The advertisement information definition unit 21 defines advertisement information depending on operations performed by the advertiser.

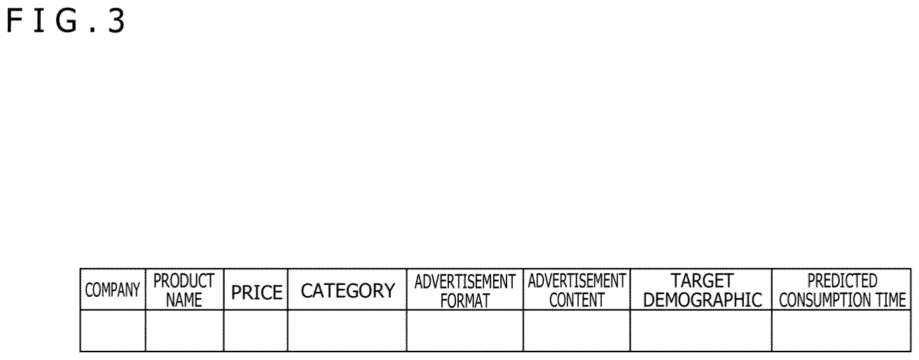

FIG. 3 is a diagram illustrating an example of advertisement information.

In the example of FIG. 3, as advertisement information, a company, a product name, a price, a category, an advertisement format, advertisement content, a target demographic, and predicted consumption time are defined.

In the company, the names of companies that are advertisers are recorded, and in the product name, the names of advertisement targets are recorded. In the price, the prices of advertisement targets are recorded, and in the category, the types of advertisement targets, such as beverages, foods, locations, and events, are recorded. Note that the advertisement target includes not only objects such as beverages and foods but also services such as events.

In the advertisement content, objects and people appearing in advertisements, such as dogs, cats, and adult women, are recorded, and in the predicted consumption time, the time predicted for consumers to take consumption behavior after seeing advertisements is recorded.

The advertisement information definition unit 21 supplies the defined advertisement information to an advertisement information accumulation unit 31 of the advertising agency server 2 of FIG. 2. Note that, although it has been described in FIG. 1 that the advertiser terminal 1 is connected to the advertising agency server 2 via the network, the advertiser terminal 1 may be directly connected to the advertising agency server 2 by wireless or wired communication. In this case, the advertisement information is supplied from the advertiser terminal 1 to the advertising agency server 2 using wireless or wired communication.

The advertising agency server 2 includes the advertisement information accumulation unit 31 and a communication unit 32.

The advertisement information accumulation unit 31 holds the advertisement information supplied from the advertiser terminal 1.

The communication unit 32 communicates with other apparatuses such as the advertisement presentation vehicle 3 via the network. Specifically, the communication unit 32 transmits the advertisement information held in the advertisement information accumulation unit 31 to the advertisement presentation vehicle 3.

### —Advertisement Presentation Vehicle 3

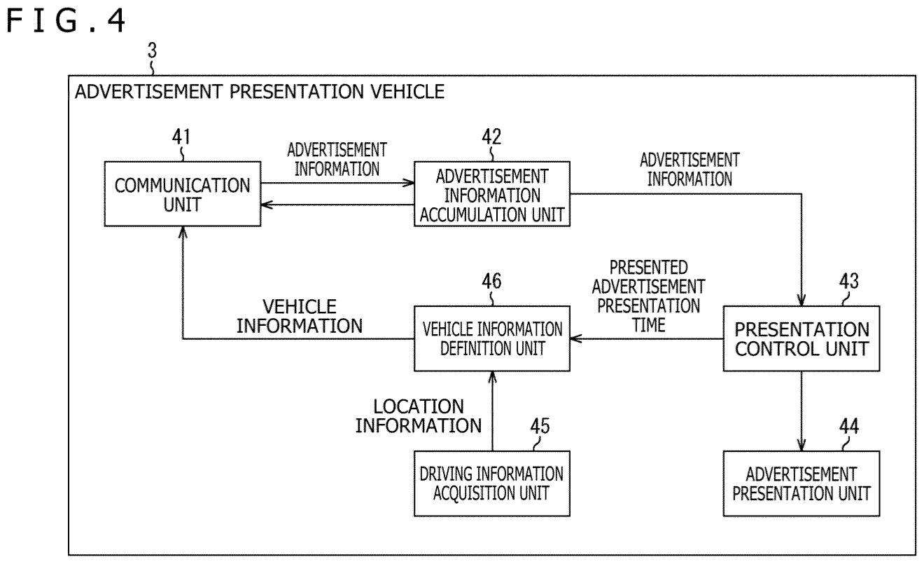

FIG. 4 is a block diagram illustrating a configuration example of the advertisement presentation vehicle 3.

As illustrated in FIG. 4, the advertisement presentation vehicle 3 includes a communication unit 41, an advertisement information accumulation unit 42, a presentation control unit 43, an advertisement presentation unit 44, a driving information acquisition unit 45, and a vehicle information definition unit 46.

The communication unit 41 communicates with other apparatuses such as the advertising agency server 2 and the advertisement effectiveness measurement server 5 via the network. Specifically, the communication unit 41 receives the advertisement information transmitted from the advertising agency server 2 and supplies the advertisement information to the advertisement information accumulation unit 42. Further, the communication unit 41 transmits the vehicle information supplied from the vehicle information definition unit 46 to the advertisement effectiveness measurement server 5 together with the advertisement information held in the advertisement information accumulation unit 42.

The advertisement information accumulation unit 42 holds the advertisement information supplied from the communication unit 41.

The presentation control unit 43 acquires advertisement information from the advertisement information accumulation unit 42 and acquires advertisement images or advertisement audio corresponding to the advertisement information from the advertising agency server 2 via the network, for example. The presentation control unit 43 supplies the advertisement images or the advertisement audio to the advertisement presentation unit 44 and causes the advertisement presentation unit 44 to display the advertisement images or output the advertisement audio.

The presentation control unit 43 supplies information indicating the advertisements presented by the advertisement presentation unit 44 and the time at which the advertisements have been presented to the vehicle information definition unit 46.

The advertisement presentation unit 44 includes a display or a speaker. The advertisement presentation unit 44 presents advertisements to consumers under the control of the presentation control unit 43. Note that it is also possible to put up, as the advertisement presentation unit 44, a poster or a wrapping material having printed thereon an advertisement image to the advertisement presentation vehicle 3.

The driving information acquisition unit 45 acquires location information regarding the advertisement presentation vehicle 3 on the basis of GNSS (Global Navigation Satellite System) signals received from GNSS satellites, for example, and supplies the location information to the vehicle information definition unit 46.

The vehicle information definition unit 46 records the information supplied from the presentation control unit 43 and the driving information acquisition unit 45 as vehicle information, together with information regarding the advertisement presentation vehicle 3.

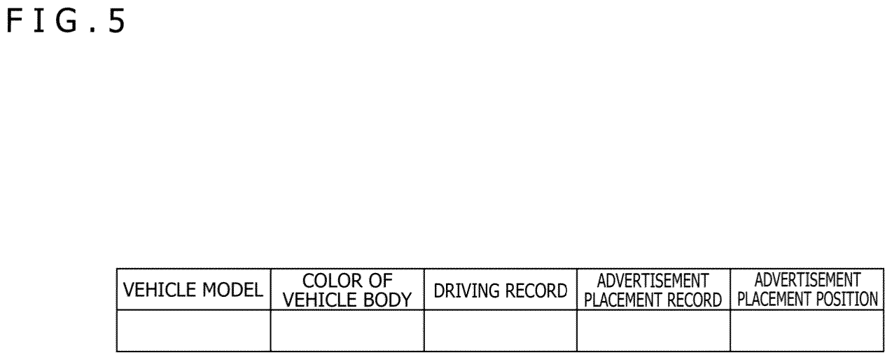

FIG. 5 is a diagram illustrating an example of vehicle information.

In the example of FIG. 5, as vehicle information, a vehicle model, a color of vehicle body, a driving record, an advertisement placement record, and an advertisement placement position are defined.

In the vehicle model, the type of the advertisement presentation vehicle 3 is recorded, and in the color of vehicle body, the color of the vehicle body of the advertisement presentation vehicle 3 is recorded. In the driving record, time-series data (history) on location information regarding the advertisement presentation vehicle 3 is recorded, and in the advertisement placement record, presented advertisements and the presentation time of the advertisements are recorded. In the advertisement placement position, the positions of advertising media on the vehicle body of the advertisement presentation vehicle 3, such as windows or side surfaces, are recorded.

The vehicle information definition unit 46 supplies the defined vehicle information to the communication unit 41 of FIG. 4.

### —Personal Terminal 4

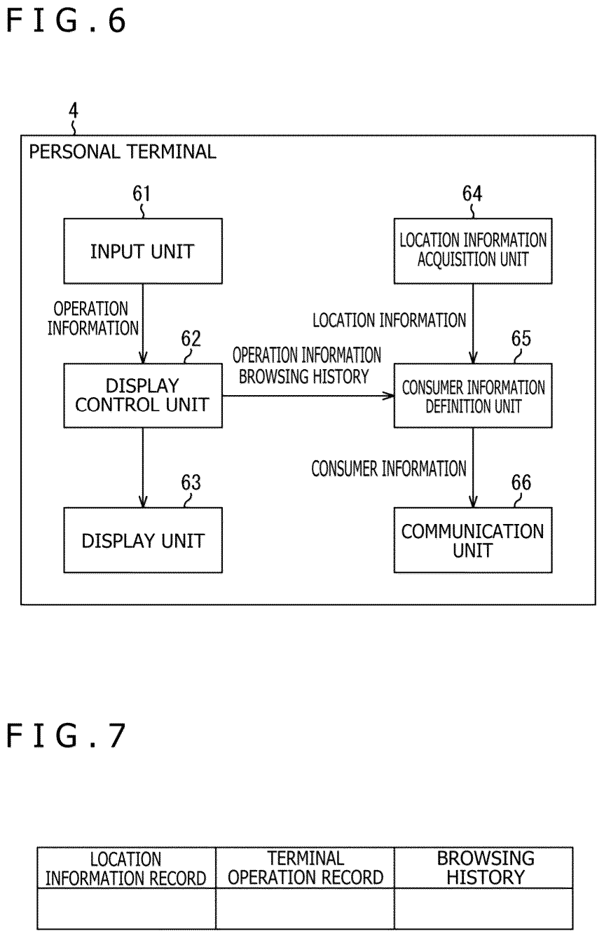

FIG. 6 is a block diagram illustrating a configuration example of the personal terminal 4.

As illustrated in FIG. 6, the personal terminal 4 includes an input unit 61, a display control unit 62, a display unit 63, a location information acquisition unit 64, a consumer information definition unit 65, and a communication unit 66.

The input unit 61 receives operations input by the consumer and supplies operation information indicating the content of the operations to the display control unit 62.

The display control unit 62 causes the display unit 63 to display screens of browsers or applications, for example. The display control unit 62 controls the screens of the browsers or the applications on the basis of the operation information supplied from the input unit 61. The display control unit 62 supplies the operation information and information indicating a browsing history to the consumer information definition unit 65.

The display unit 63 displays various screens under the control of the display control unit 62.

The location information acquisition unit 64 acquires location information regarding the personal terminal 4 on the basis of GNSS signals received from GNSS satellites, for example, and supplies the location information to the consumer information definition unit 65.

The consumer information definition unit 65 records the information supplied from the display control unit 62 and the location information acquisition unit 64 as consumer information.

FIG. 7 is a diagram illustrating an example of consumer information.

In the example of FIG. 7, as consumer information, a location information record, a terminal operation record, and a browsing history are defined.

In the location information record, time-series data (history) on location information regarding the consumer (personal terminal 4) is recorded, and in the terminal operation record, when the consumer has operated the terminal is recorded. In the browsing history, content of an operation performed by the consumer on browsers or applications and the content viewed by the consumer on the browsers is recorded.

The consumer information definition unit 65 supplies the defined consumer information to the communication unit 66 of FIG. 6.

The communication unit 66 communicates with other apparatuses such as the advertisement effectiveness measurement server 5 via the network. Specifically, the communication unit 66 transmits the consumer information supplied from the consumer information definition unit 65 to the advertisement effectiveness measurement server 5. Note that information to be recorded in consumer information regarding a certain consumer may be acquired by multiple devices such that the location information record may be acquired by a smartphone, while the terminal operation record and the browsing history may be acquired by a PC.

### —Advertisement Effectiveness Measurement Server 5

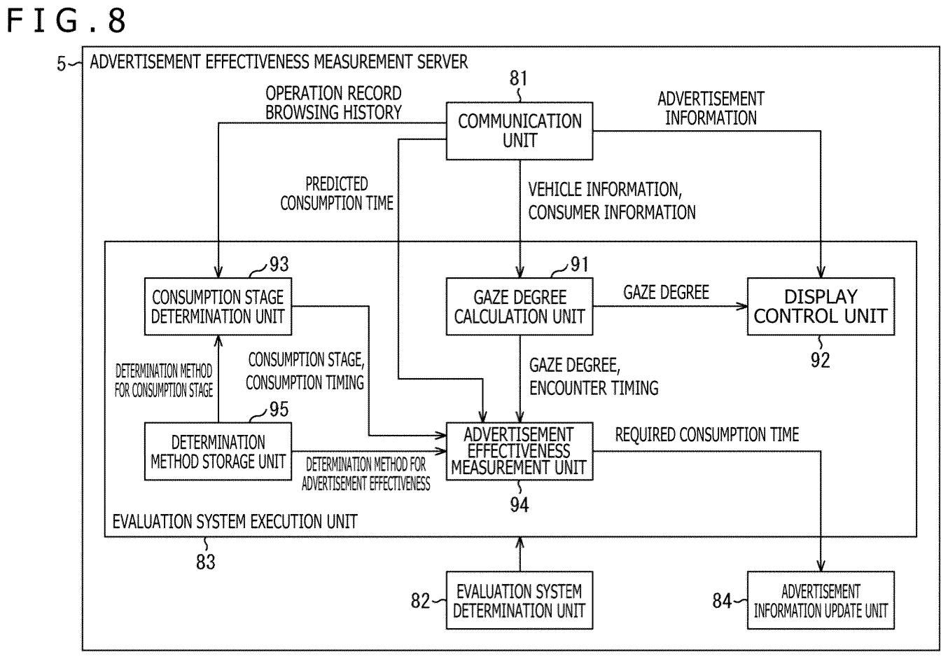

FIG. 8 is a block diagram illustrating a configuration example of the advertisement effectiveness measurement server 5.

As illustrated in FIG. 8, the advertisement effectiveness measurement server 5 includes a communication unit 81, an evaluation system determination unit 82, an evaluation system execution unit 83, and an advertisement information update unit 84.

The communication unit 81 communicates with other apparatuses such as the advertisement presentation vehicle 3 and the personal terminal 4 via the network. Specifically, the communication unit 81 receives the vehicle information and advertisement information transmitted from the advertisement presentation vehicle 3, and the consumer information transmitted from the personal terminal 4. The communication unit 81 supplies the advertisement information, the vehicle information, and the consumer information to the evaluation system execution unit 83.

The evaluation system determination unit 82 determines, among a passive evaluation system, an active evaluation system, and a latent evaluation system for measuring the effectiveness of advertisements, for example, an evaluation system to be executed by the evaluation system execution unit 83. The evaluation system to be executed is determined on the basis of the consumer information acquired from the communication unit 81 via a route which is not illustrated, for example. The evaluation system determination unit 82 causes the evaluation system execution unit 83 to execute the evaluation system selected from the three evaluation systems.

The evaluation system execution unit 83 executes the evaluation system selected by the evaluation system determination unit 82 to measure the effectiveness of advertisements on the basis of advertisement information, vehicle information, and consumer information. Note that details of the passive evaluation system, the active evaluation system, and the latent evaluation system to be executed by the evaluation system execution unit 83 are described later.

The evaluation system execution unit 83 includes a gaze degree calculation unit 91, a display control unit 92, a consumption stage determination unit 93, an advertisement effectiveness measurement unit 94, and a determination method storage unit 95.

The gaze degree calculation unit 91 determines encountered advertisements that are advertisements encountered by the consumer, on the basis of the location information record of the consumer recorded in the consumer information supplied from the communication unit 81, and of the driving record of the advertisement presentation vehicle 3 recorded in the vehicle information. For example, in a case where the location information regarding the consumer matches the location information regarding the advertisement presentation vehicle 3 at a certain time point, the gaze degree calculation unit 91 refers to the vehicle information and determines an advertisement presented by the advertisement presentation vehicle 3 at the time point as an encountered advertisement.

The gaze degree calculation unit 91 calculates the gaze degree of the consumer for the encountered advertisement on the basis of the location information record, terminal operation record, and browsing history recorded in the consumer information, as well as of the driving record and advertisement placement position recorded in the vehicle information.

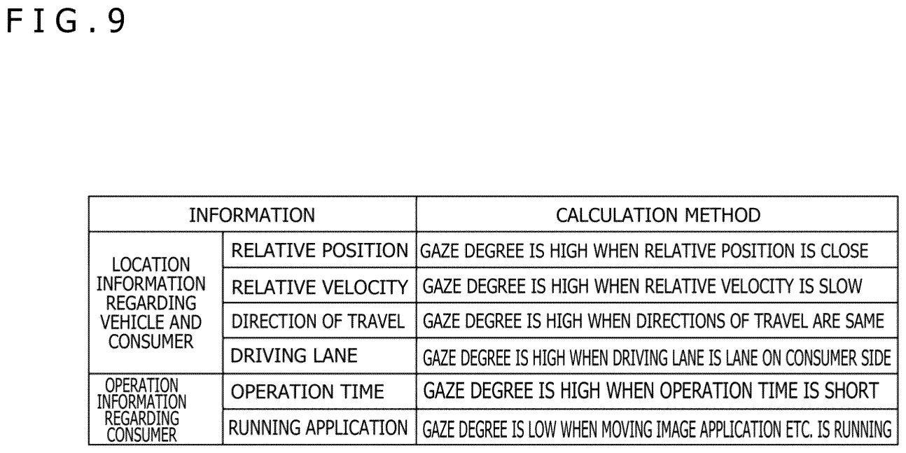

FIG. 9 is a diagram illustrating an example of a calculation method for gaze degrees.

In the example of FIG. 9, the gaze degree calculation unit 91 calculates a gaze degree on the basis of at least any of the following pieces of information regarding the consumer and an encountered advertisement when they have encountered each other: the relative position of the advertising medium to the consumer, the relative velocity of the advertising medium to the consumer, the directions of travel of the advertisement presentation vehicle 3 and the consumer, the driving lane of the advertisement presentation vehicle 3, the operation time of the personal terminal 4 by the consumer, and the application that the personal terminal 4 has been running.

The information regarding the consumer and the encountered advertisement when they have encountered each other, namely, the relative position of the advertising medium to the consumer, the relative velocity of the advertising medium to the consumer, the directions of travel of the advertisement presentation vehicle 3 and the consumer, and the driving lane of the advertisement presentation vehicle 3, is acquired on the basis of the location information record of the consumer and the driving record of the advertisement presentation vehicle 3. Further, the operation time of the personal terminal 4 by the consumer and the application that the personal terminal 4 has been running are acquired on the basis of the terminal operation record and browsing history of the consumer.

The gaze degree calculation unit 91 calculates a higher value as a gaze degree in a situation where the consumer visually recognizes the advertisement more easily, on the basis of these pieces of information.

For example, the gaze degree calculation unit 91 calculates a high value as a gaze degree when the relative position of the advertising medium to the consumer is close and calculates a high value as a gaze degree when the relative velocity of the advertising medium to the consumer is slow. Further, the gaze degree calculation unit 91 calculates a high value as a gaze degree when the directions of travel of the advertisement presentation vehicle 3 and the consumer are the same. In a case where the consumer is a pedestrian, the gaze degree calculation unit 91 calculates a high value as a gaze degree when the driving lane of the advertisement presentation vehicle 3 is a lane on the pedestrian side. The gaze degree calculation unit 91 calculates a high value as a gaze degree when the operation time of the personal terminal 4 by the consumer is short and calculates a low value as a gaze degree in a case where the personal terminal 4 is running a moving image application or the like.

The gaze degree calculation unit 91 supplies information indicating the gaze degree for the encountered advertisement to the display control unit 92 and the advertisement effectiveness measurement unit 94 of FIG. 8. Further, the gaze degree calculation unit 91 supplies information indicating encounter timing, which is the timing at which the consumer has encountered the encountered advertisement, to the advertisement effectiveness measurement unit 94.

The display control unit 92 causes the display unit 63 of the personal terminal 4 to display a list of encountered advertisements arranged in descending order of gaze degree calculated by the gaze degree calculation unit 91. The display control unit 92 causes the display unit 63 to display some of the information recorded in the advertisement information supplied from the communication unit 81, as a list of advertisements, for example.

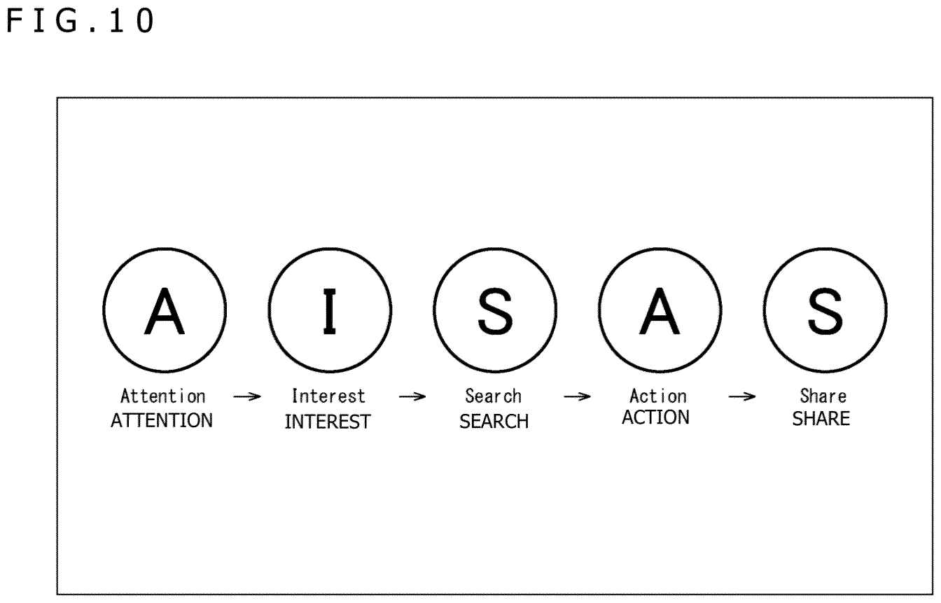

The consumption stage determination unit 93 determines a consumption stage that is the stage of consumption behavior that the consumer has taken, on the basis of the terminal operation record and browsing history recorded in the consumer information supplied from the communication unit 81. The consumption stage determination unit 93 acquires information indicating a determination method for consumption stages from the determination method storage unit 95 and determines the consumption stage with the determination method. For example, the consumption stage determination unit 93 determines the consumption stage on the basis of the AISAS model illustrated in FIG. 10.

In the AISAS model, consumption behavior that consumers take is classified into five stages, namely, Attention, Interest, Search, Action, and Share.

The attention stage is a stage on which consumers have seen advertisements delivered to allow the advertisement targets to be recognized by the latent demographic. The interest stage is a stage on which, after seeing advertisements, consumers have become interested or concerned about the advertisement targets.

The search stage is a stage on which consumers have compared products or services that are advertisement targets with other products or services using search engines, social media, or the like to make searches or collecting information. The action stage is a stage on which, after comparing and considering products or services, consumers have purchased the advertisement targets. The share stage is a stage on which consumers who have used advertisement targets and been satisfied with them have shared (disseminated) information regarding the advertisement targets on social media or the like.

Note that, in a case where the consumer has encountered advertisements, the consumer is considered to have already taken consumption behavior on the attention stage and the interest stage, and hence the consumption stage determination unit 93 determines whether the consumption behavior is on the search stage, the action stage, or the share stage. Note that the consumption stage is determined using different determination methods depending on evaluation systems executed by the entire evaluation system execution unit 83.

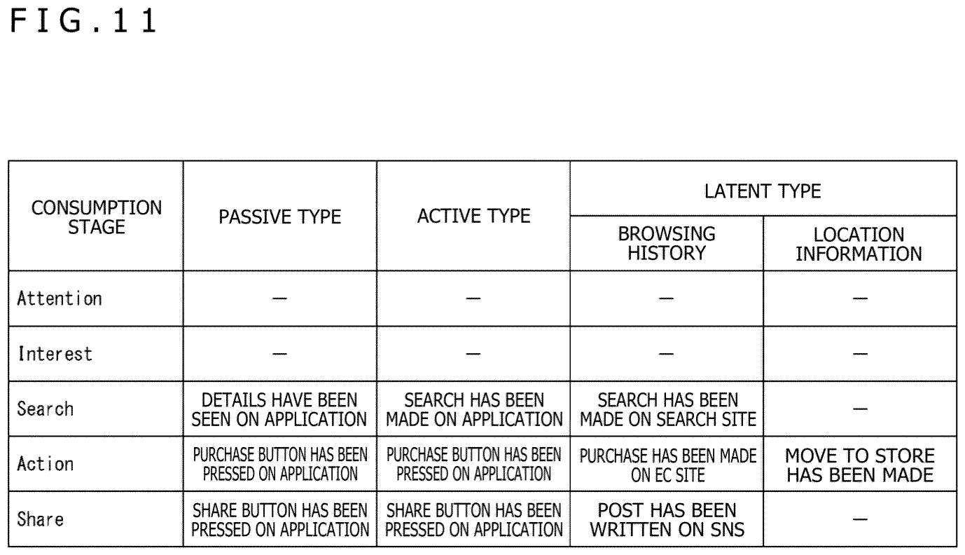

FIG. 11 is a diagram illustrating an example of a determination method for consumption stages depending on evaluation systems.

As illustrated in FIG. 11, in the passive evaluation system, in a case where the consumer has seen details about an advertisement on an application, the consumption stage determination unit 93 determines that the consumer has taken consumption behavior on the search stage. Further, in a case where the consumer has pressed the purchase button on the application, the consumption stage determination unit 93 determines that the consumer has taken consumption behavior on the action stage. Moreover, in a case where the consumer has pressed the share button on the application, the consumption stage determination unit 93 determines that the consumer has taken consumption behavior on the share stage.

In the active evaluation system, in a case where the consumer has searched for an advertisement on an application, the consumption stage determination unit 93 determines that the consumer has taken consumption behavior on the search stage. Further, in a case where the consumer has pressed the purchase button on the application, the consumption stage determination unit 93 determines that the consumer has taken consumption behavior on the action stage. Moreover, in a case where the consumer has pressed the share button on the application, the consumption stage determination unit 93 determines that the consumer has taken consumption behavior on the share stage.

In the latent evaluation system, in a case where the consumer has searched for information regarding an advertisement target on a search site, the consumption stage determination unit 93 determines that the consumer has taken consumption behavior on the search stage. Further, in a case where the consumer has purchased the advertisement target on an EC site, the consumption stage determination unit 93 determines that the consumer has taken consumption behavior on the action stage. Moreover, in a case where the consumer has posted information regarding the advertisement target on SNS (Social Networking Service), the consumption stage determination unit 93 determines that the consumer has taken consumption behavior on the share stage.

In the latent evaluation system, the consumption stage determination unit 93 can identify the fact that the consumer has made searches on the search site, has made a purchase on the EC site, or has written posts on SNS, on the basis of the browsing history, thereby determining the consumption stage. Note that the consumption stage determination unit 93 can also identify the fact that the consumer has moved to a store related to the advertisement target, on the basis of the location information record of the consumer, thereby determining that the consumer has taken consumption behavior on the action stage.

In a case where the consumer has taken consumption behavior, the consumption stage determination unit 93 supplies information indicating consumption timing, which is the timing at which the consumer has taken consumption behavior, to the advertisement effectiveness measurement unit 94 of FIG. 8 together with information indicating the consumption stage.

The advertisement effectiveness measurement unit 94 determines how much an advertisement has influenced consumption behavior, as the effectiveness of the advertisement. The advertisement effectiveness measurement unit 94 acquires information indicating a determination method for the effectiveness of advertisements from the determination method storage unit 95, for example, and calculates an evaluation value according to the method. The advertisement effectiveness measurement unit 94 determines the effectiveness of the advertisement on the basis of the calculated evaluation value. An evaluation value V is calculated using a weight w and an evaluation formula f based on at least any of a gaze degree G and a consumption stage C, as represented by Equation (1) below.

$$[ Math . 1 ]$$

$$V = w \times f ( G , C ) \qquad ( 1 )$$

In Equation (1), the value of the weight w is set on the basis of required consumption time that is the time required from encounter timing to consumption timing, and of predicted consumption time that is the time predicted to be required from encounter timing to consumption timing. Note that the predicted consumption time is defined depending on the categories of the advertisement targets in the advertisement information.

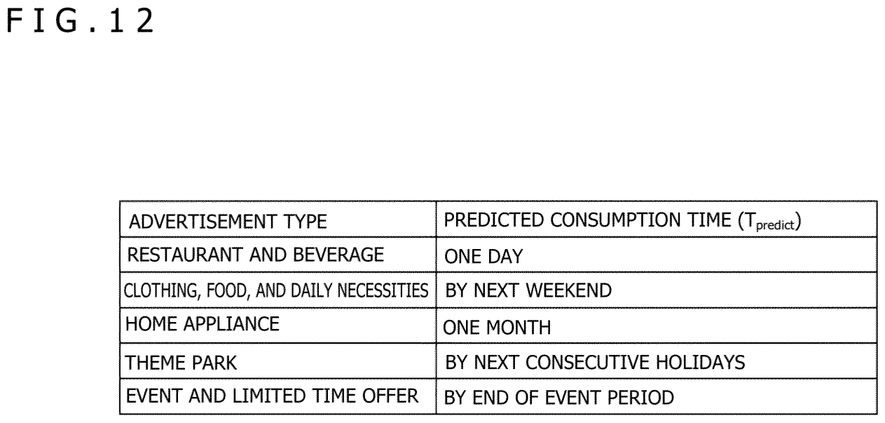

FIG. 12 is a diagram illustrating examples of predicted consumption time depending on the categories of advertisement targets.

In the example of FIG. 12, as a predicted consumption time T_{predict} for restaurants and beverages, the period of one day is defined, and as the predicted consumption time T_{predict} for clothing, food, and daily necessities, the period from encounter timing to the next weekend is defined.

As the predicted consumption time T_{predict} for home appliances, the period of one month is defined, and as the predicted consumption time T_{predict} for theme parks, the period from encounter timing to the end of the next consecutive holiday is defined. As the predicted consumption time T_{predict} for events or limited time offers, the period from encounter timing to the end of an event period is defined. Note that the predicted consumption time may be defined for each consumption stage.

The advertisement effectiveness measurement unit 94 changes the value of the weight w depending on the difference between required consumption time and predicted consumption time.

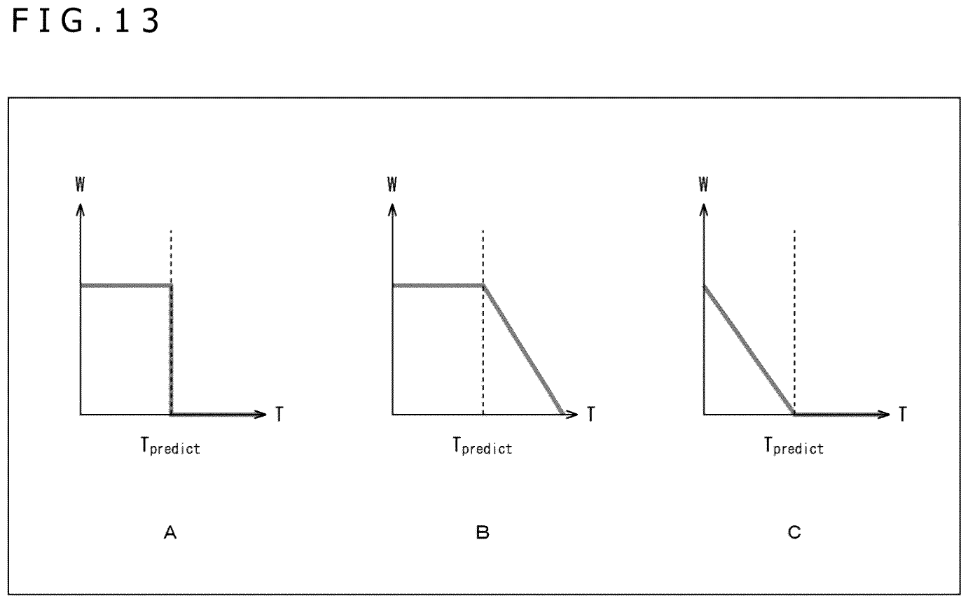

FIG. 13 depicts diagrams illustrating examples of the value of the weight w depending on the difference between required consumption time and predicted consumption time. In FIG. 13, the horizontal axis represents a required consumption time T, and the vertical axis represents the weight w.

In the example of A of FIG. 13, in a case where the required consumption time T is equal to or less than the predicted consumption time T_{predict}, the advertisement effectiveness measurement unit 94 sets a constant value as the weight w. In a case where the required consumption time T exceeds the predicted consumption time T_{predict}, the advertisement effectiveness measurement unit 94 sets the value of the weight w to 0. With the weight w being 0, the evaluation value V is also 0. Thus, the advertisement effectiveness measurement unit 94 determines that the advertisement is not the cause of the consumption behavior of the consumer.

In the example of B of FIG. 13, in a case where the required consumption time T is equal to or less than the predicted consumption time T_{predict}, the advertisement effectiveness measurement unit 94 sets a constant value as the weight w. In a case where the required consumption time T exceeds the predicted consumption time T_{predict}, the advertisement effectiveness measurement unit 94 decreases the value of the weight w as the difference between the required consumption time T and the predicted consumption time T_{predict} increases.

In the example of C of FIG. 13, in a case where the required consumption time T is equal to or less than the predicted consumption time T_{predict}, the advertisement effectiveness measurement unit 94 decreases the value of the weight w as the difference between the required consumption time T and the predicted consumption time T_{predict} decreases. In a case where the required consumption time T exceeds the predicted consumption time T_{predict}, the advertisement effectiveness measurement unit 94 sets the value of the weight w to 0.

Returning to FIG. 8, the advertisement effectiveness measurement unit 94 supplies information indicating required consumption time to the advertisement information update unit 84.

The determination method storage unit 95 stores determination methods for consumption stages and determination methods for the effectiveness of advertisements. For example, setting methods for the evaluation formula f and the weight w for calculating the evaluation value V are stored in the determination method storage unit 95.

The advertisement information update unit 84 updates the advertisement information held in the advertisement information accumulation unit 31 of the advertising agency server 2. For example, the advertisement information update unit 84 records the average value of the required consumption time actually required from encounter timing to consumption timing as predicted consumption time in the advertisement information.

### 2. Operation of Advertisement Effectiveness Measurement Server

### —Operation of Entire Advertisement Effectiveness Measurement Server 5

Next, with reference to the flowchart of FIG. 14, the processing performed by the advertisement effectiveness measurement server 5 having the configuration as described above is described.

In Step S1, the communication unit 81 acquires vehicle information from the advertisement presentation vehicle 3 and acquires consumer information from the personal terminal 4.

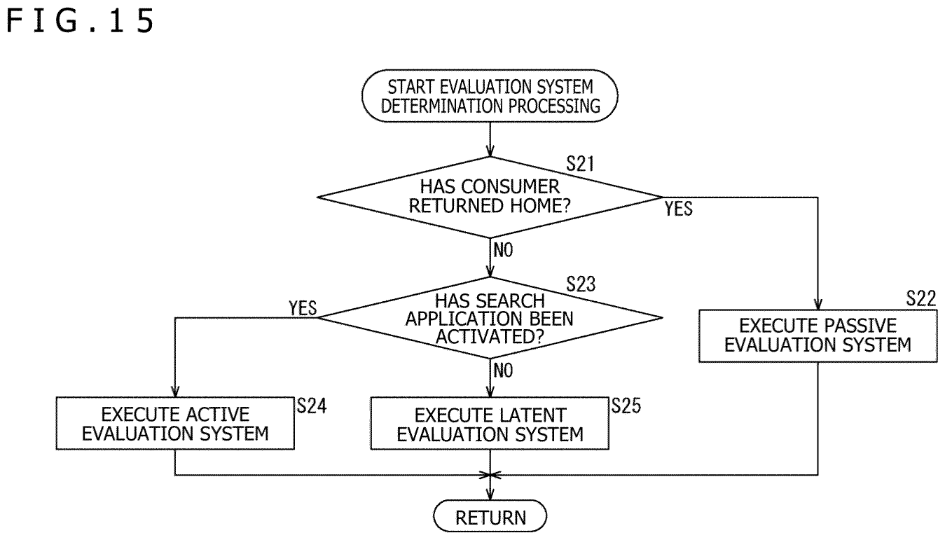

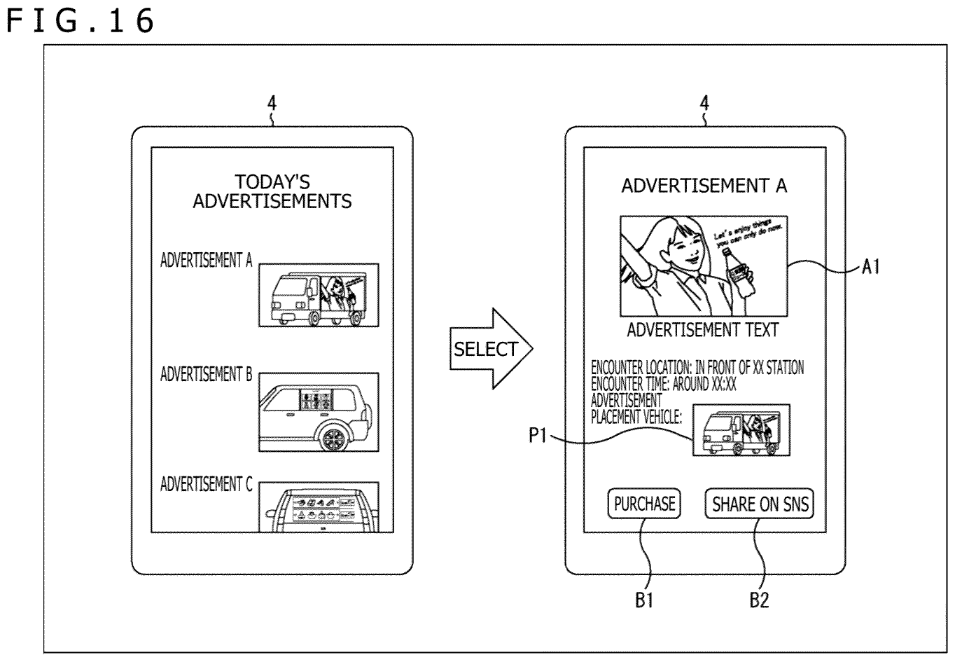

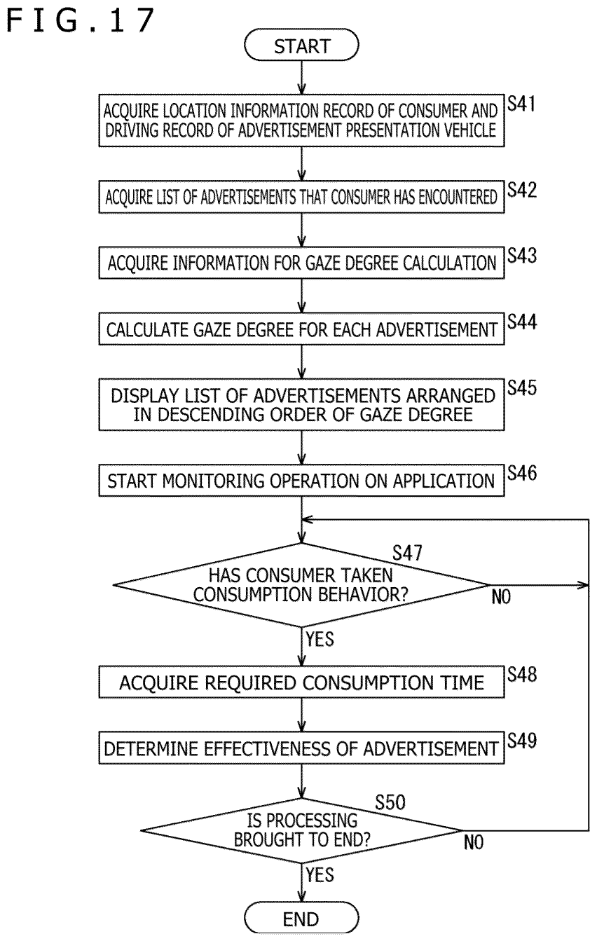

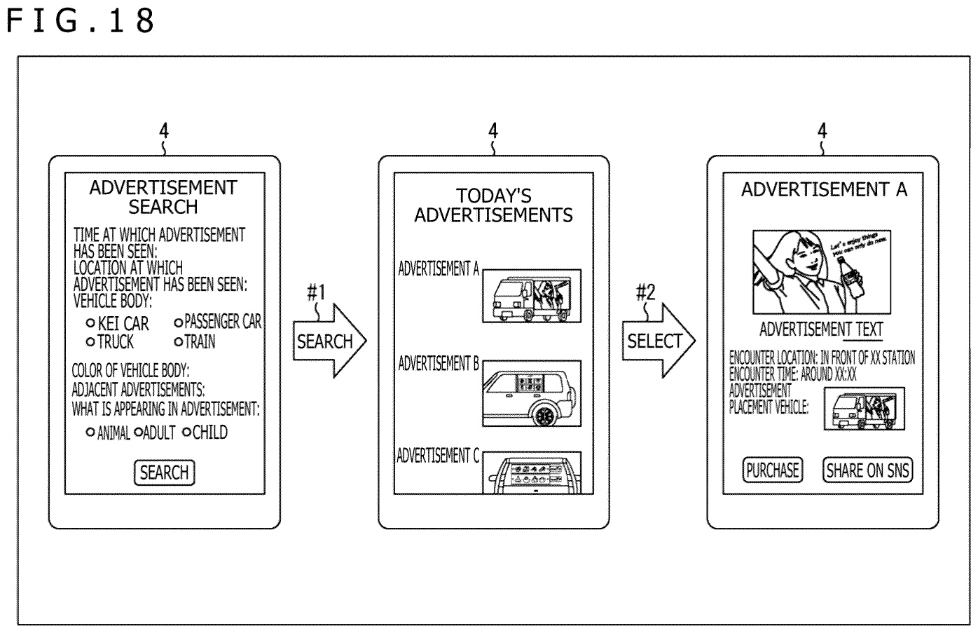

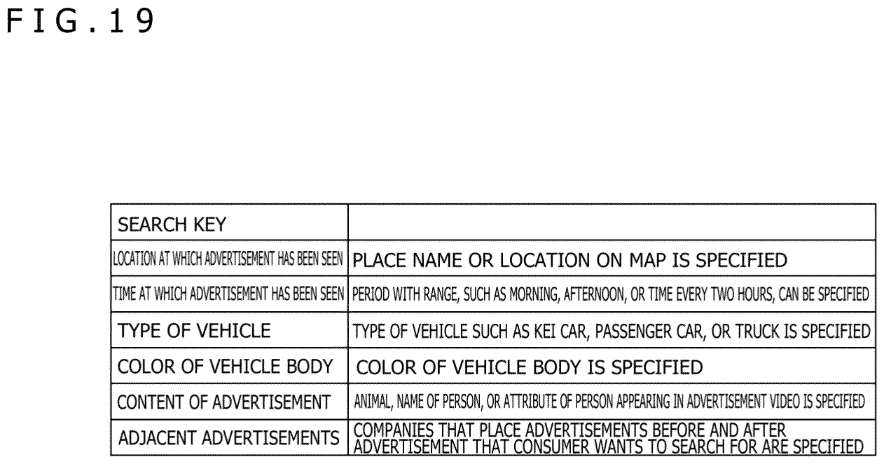

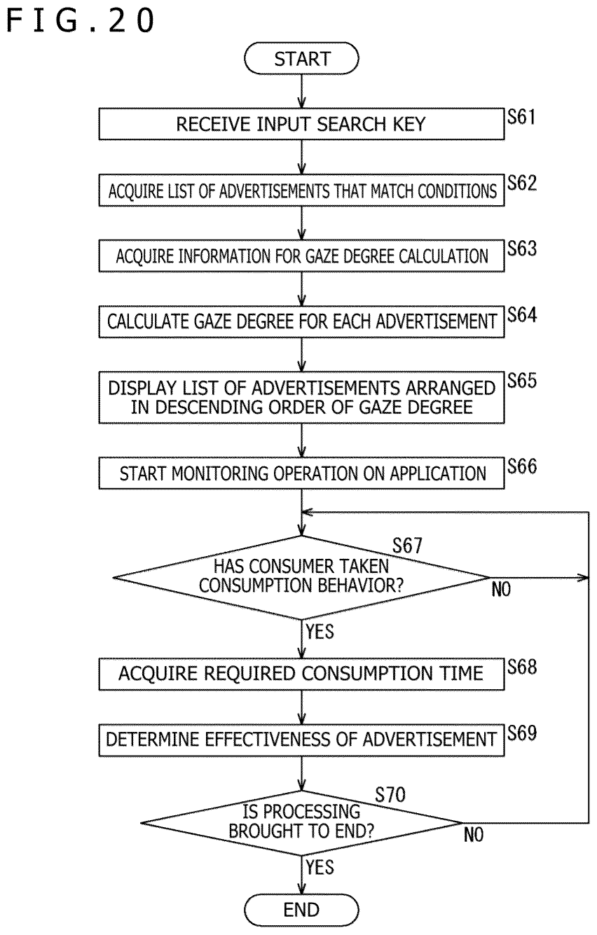

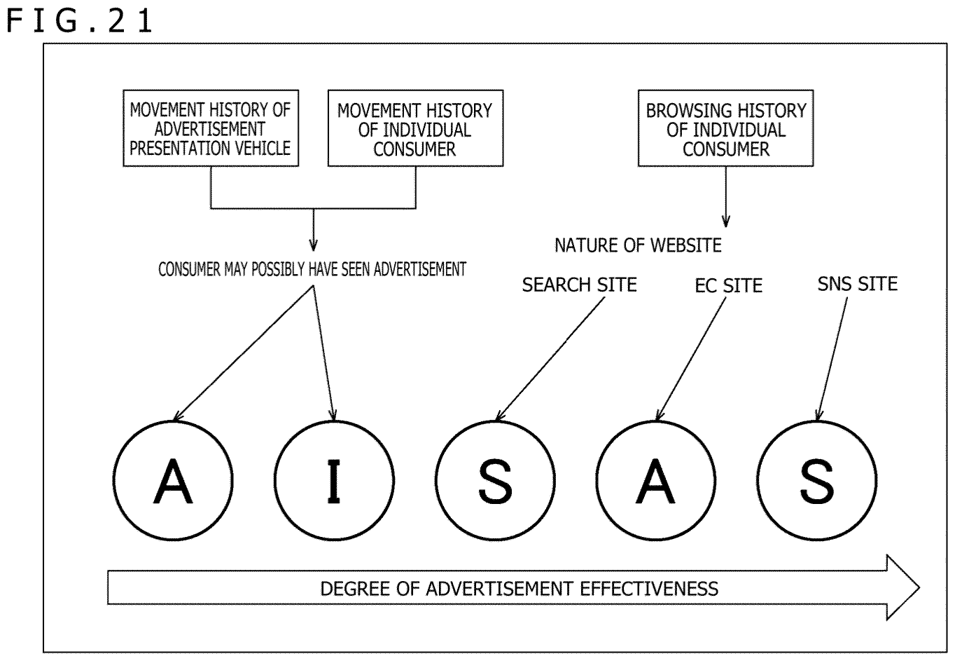

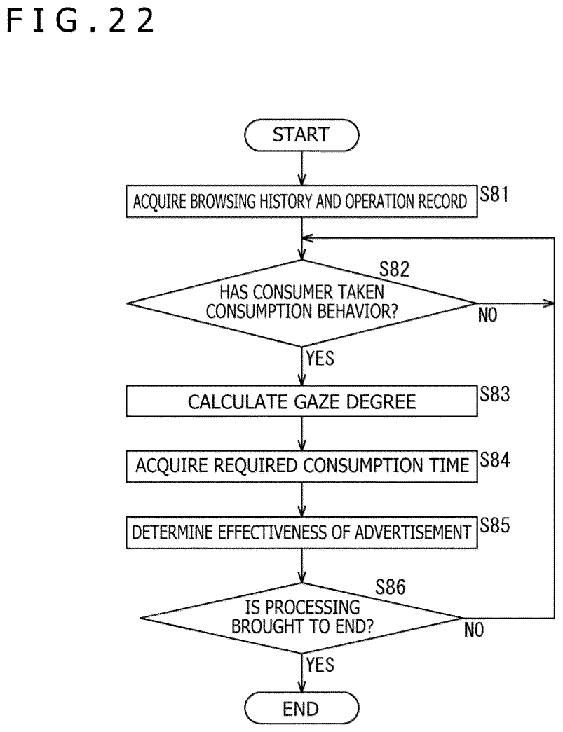

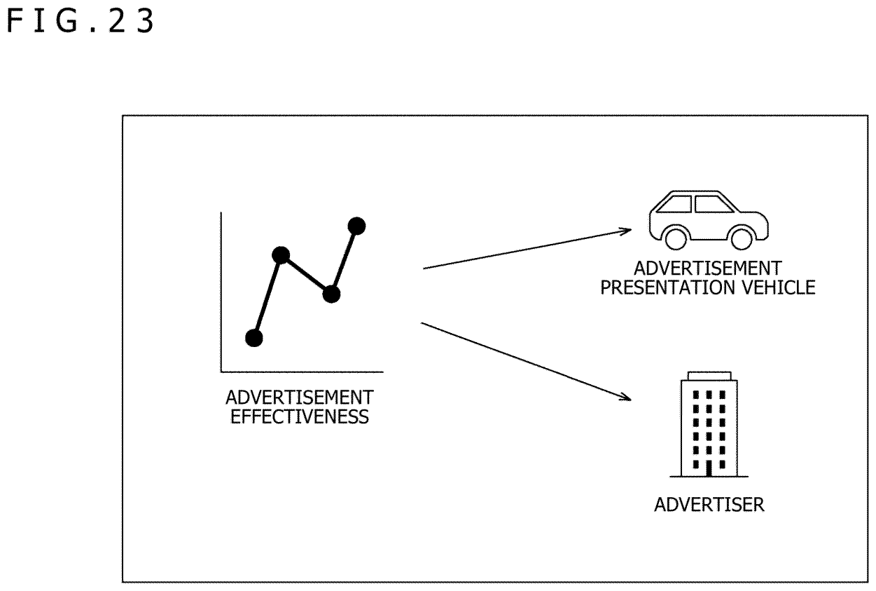

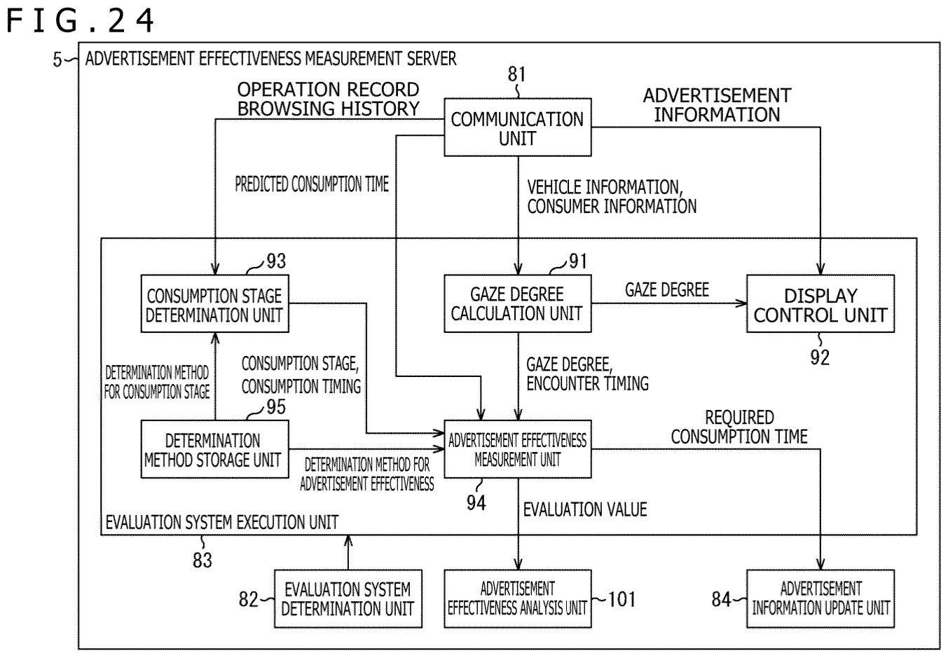

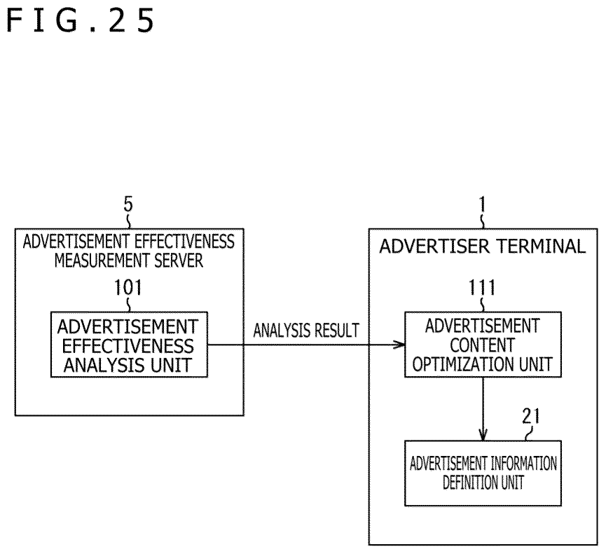

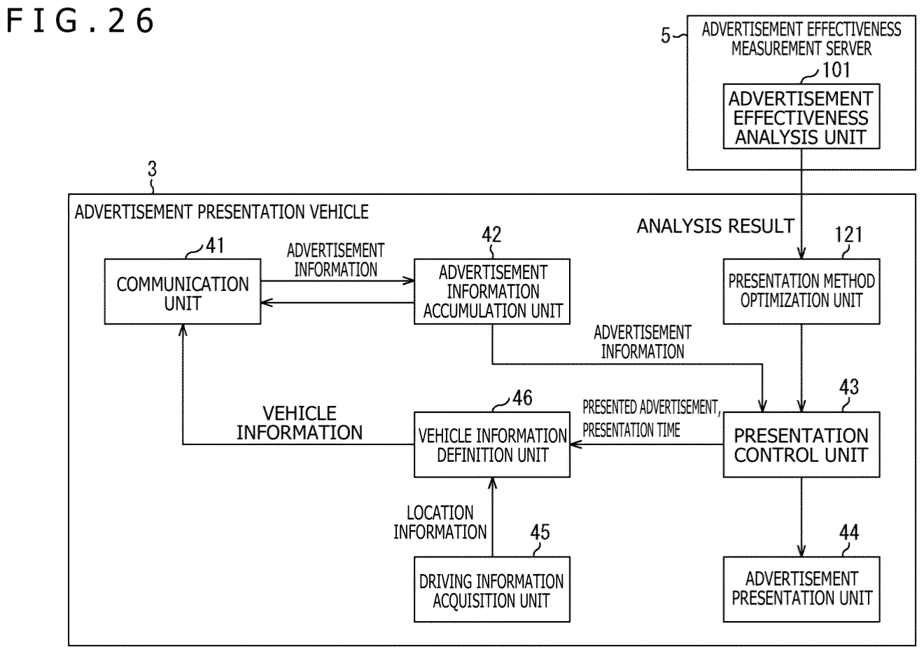

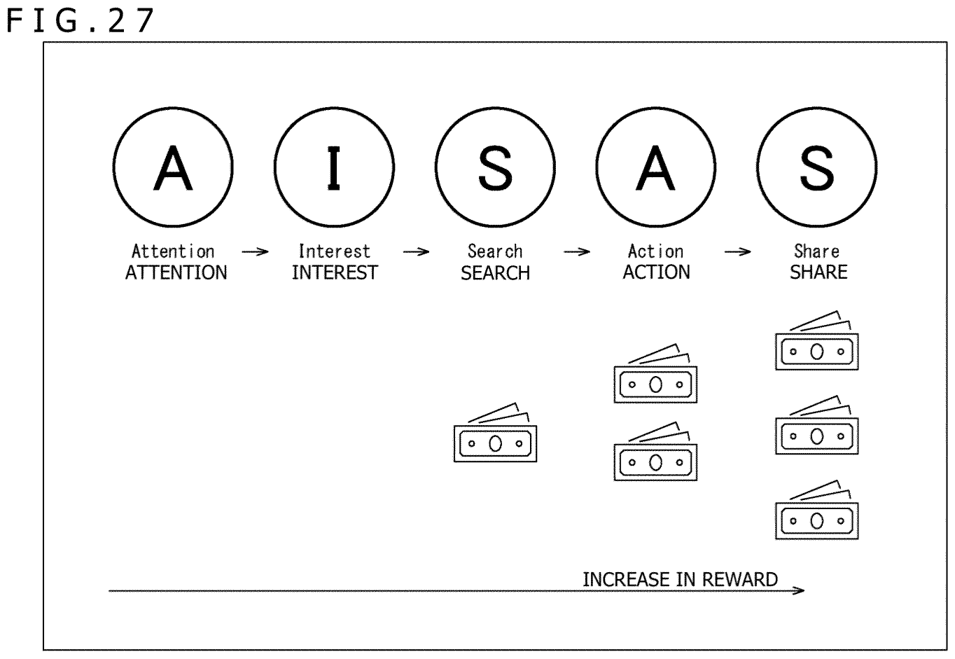

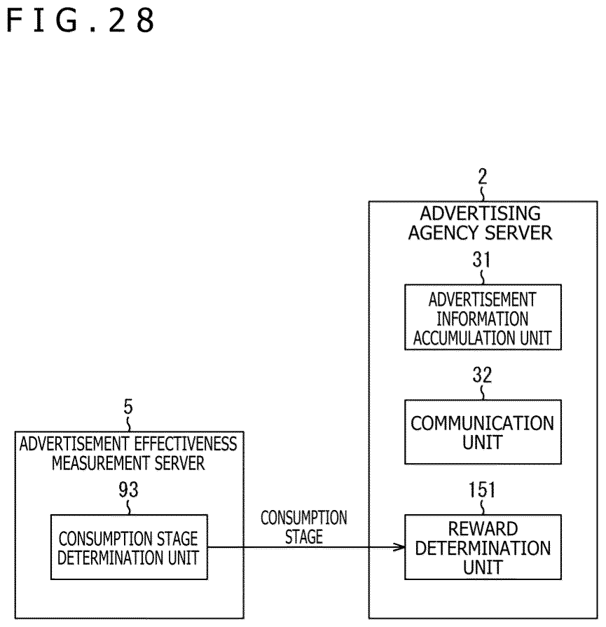

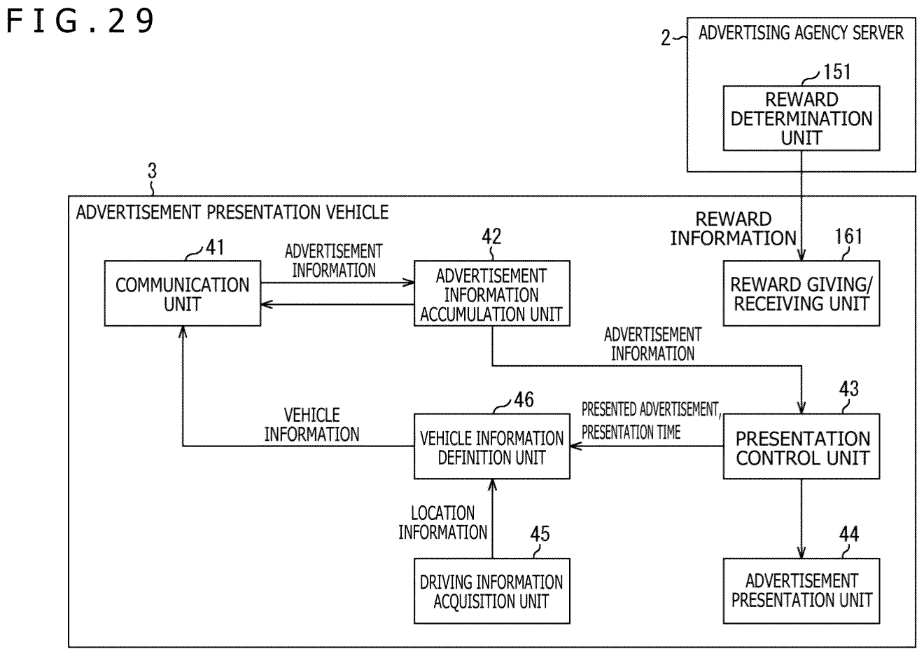

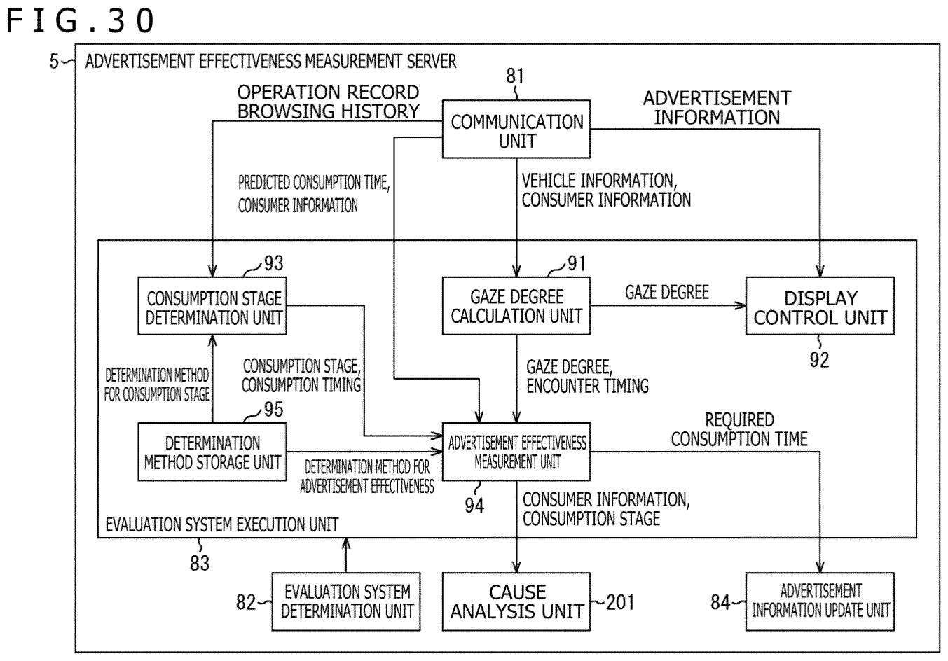

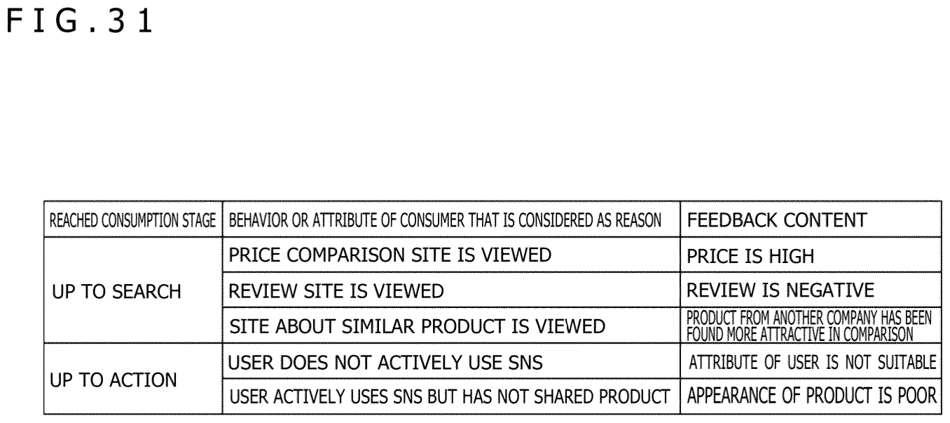

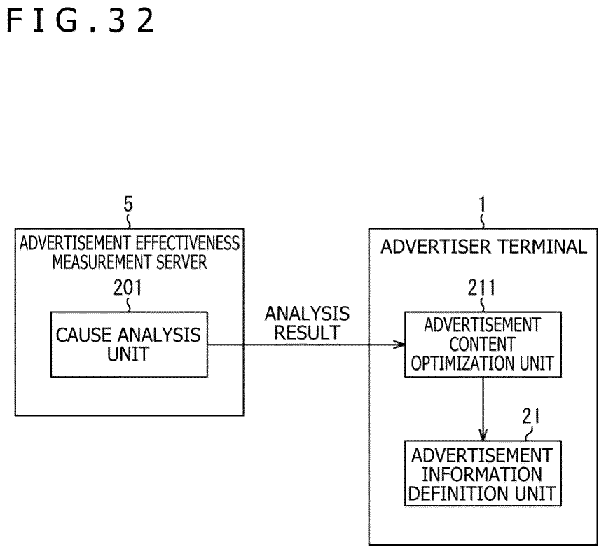

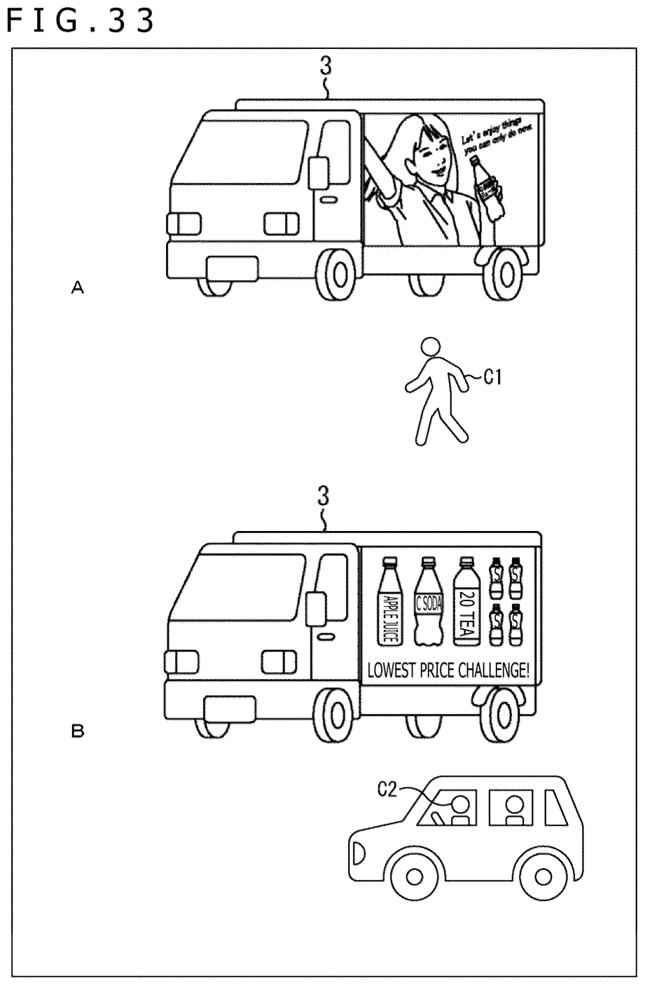

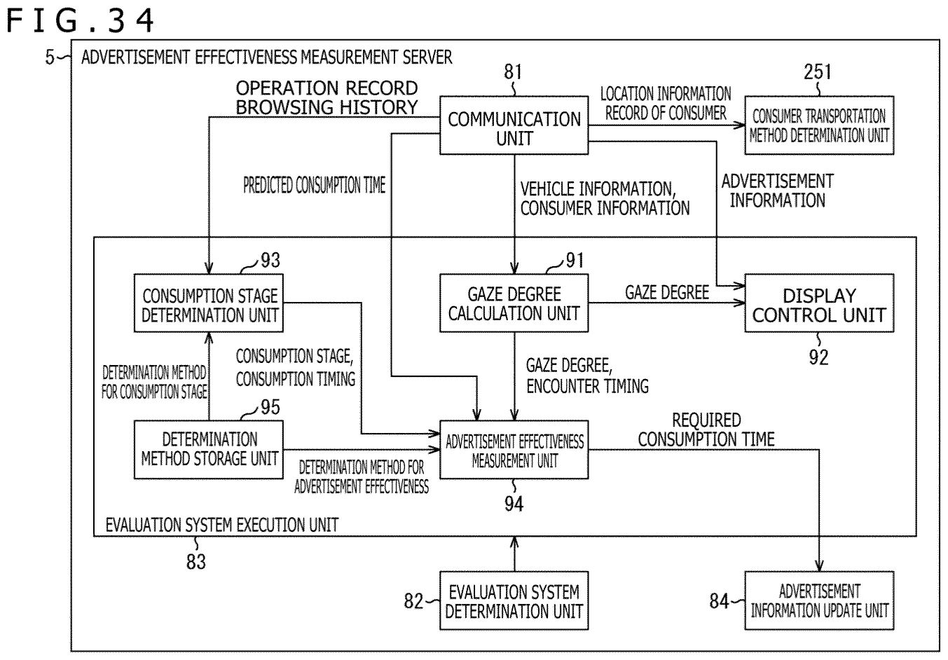

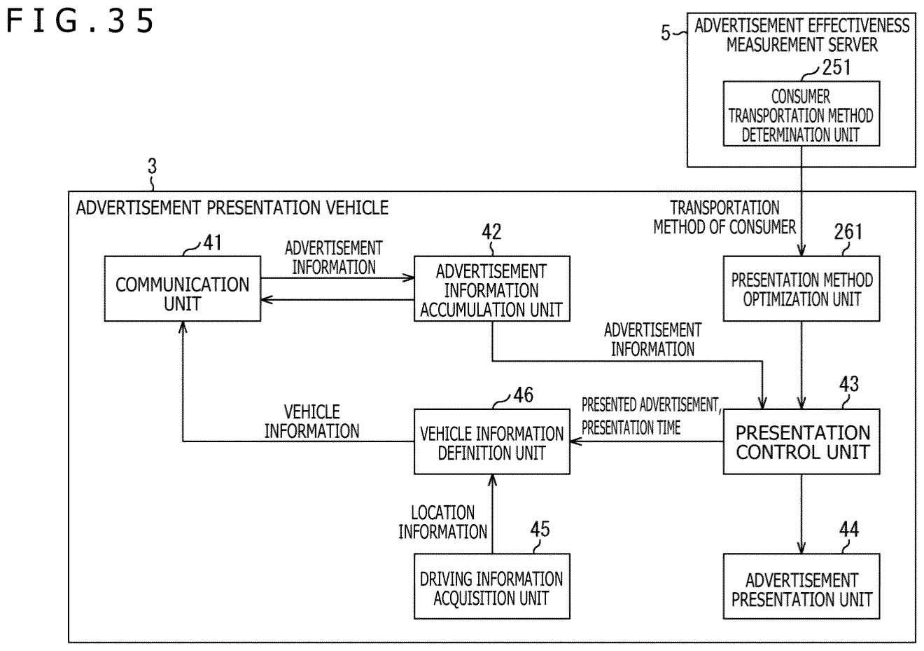

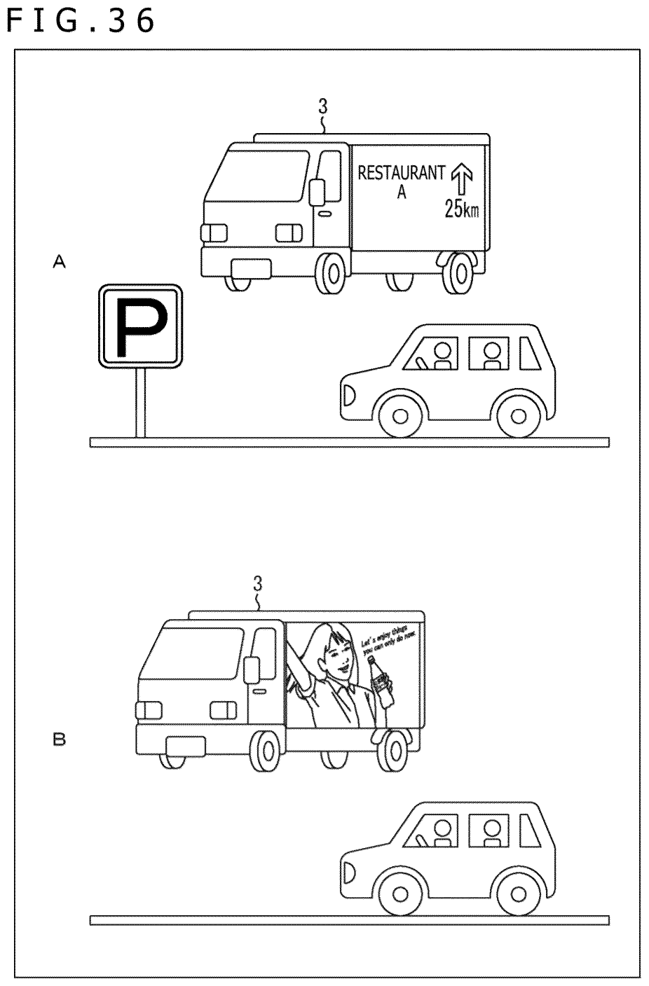

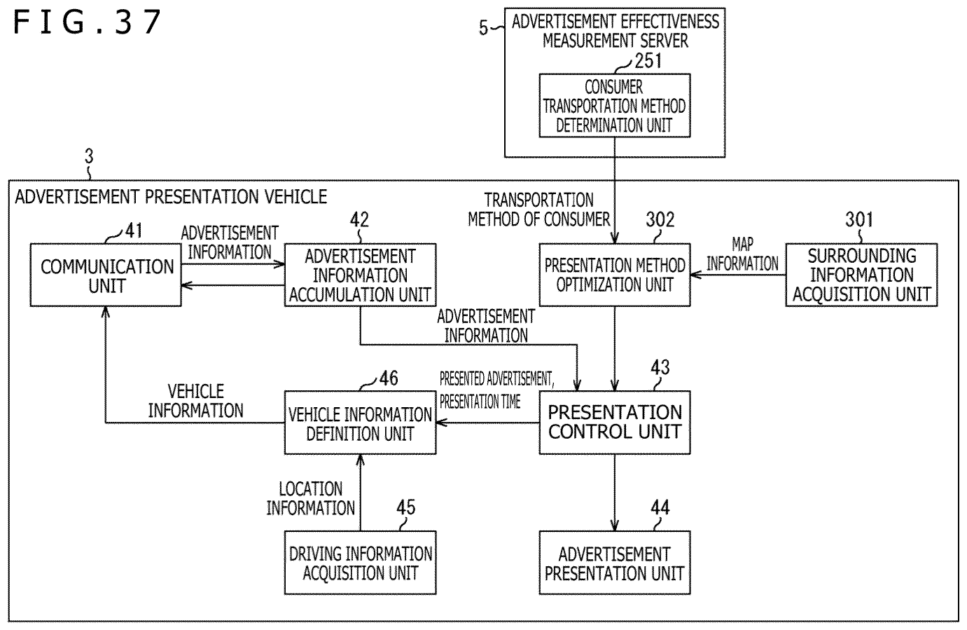

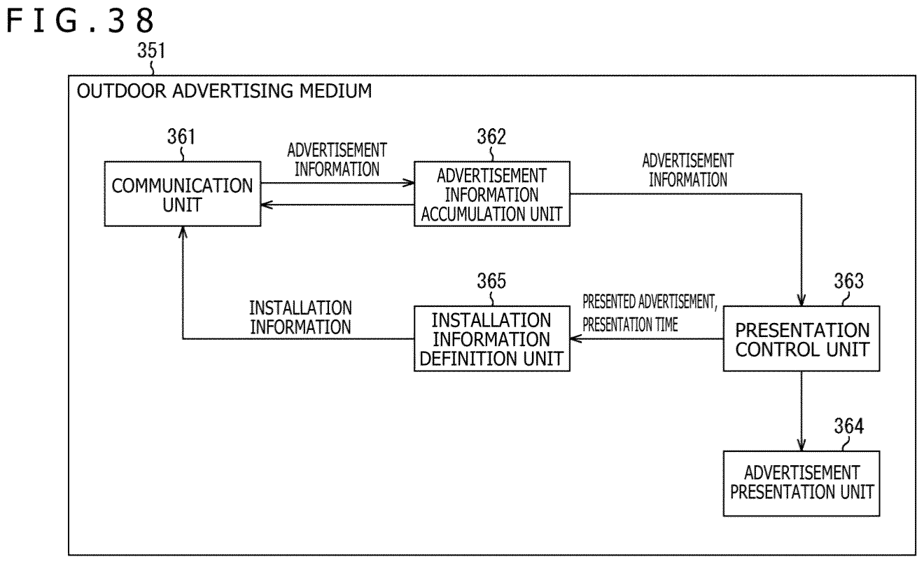

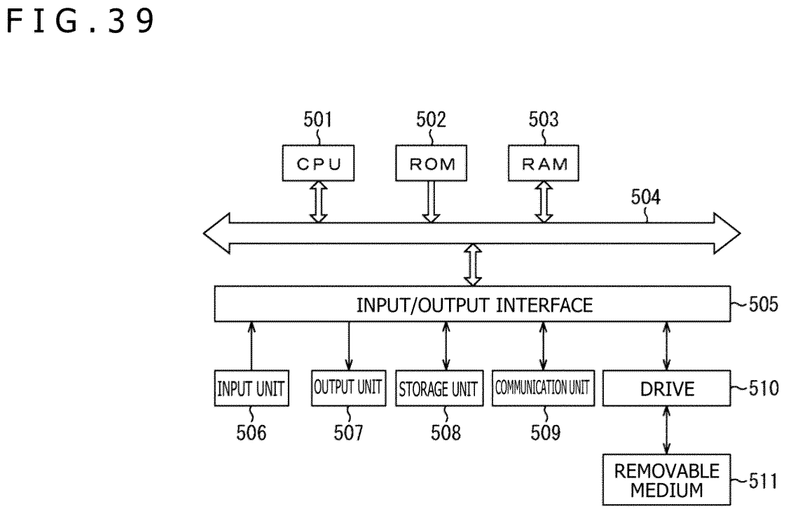

In Step S2, the evaluation system determination unit 82 performs evaluation system determination processing. Through the evaluation system determination processing, an evaluation system to be executed by the evaluation system execution unit 83 is determined on the basis of the consumer information. Details of the evaluation system determination processing are described later with reference to FIG. 15.

In Step S3, the evaluation system execution unit 83 executes the evaluation system determined by the evaluation system determination unit 82 to measure the effectiveness of the advertisement on the basis of the vehicle information and the consumer information.

In Step S4, the advertisement information update unit 84 updates the predicted consumption time recorded in the advertisement information.

In Step S5, the advertisement effectiveness measurement server 5 determines whether to end the measurement of the effectiveness of the advertisement or not. The advertisement effectiveness measurement server 5 determines to end the measurement of the effectiveness of the advertisement in a case where a predetermined time has elapsed since the encounter between the consumer and the advertisement, in a case where the consumer has taken consumption behavior on the share stage, or in a case where the advertising period has ended, for example.

In a case where it is determined in Step S5 not to end the measurement of the effectiveness of the advertisement, the processing returns to Step S1, and the subsequent processing is repeated. Meanwhile, in a case where it is determined in Step S5 to end the measurement of the effectiveness of the advertisement, the processing ends.

With reference to the flowchart of FIG. 15, the evaluation system determination processing performed in Step S2 of FIG. 14 is described.

In Step S21, the evaluation system determination unit 82 determines whether the consumer has returned home or not. For example, the evaluation system determination unit 82 determines that the consumer has returned home in a case where current location information regarding the consumer matches location information regarding his/her home or in a case where the expected time point for returning home has arrived.

In a case where it is determined in Step S21 that the consumer has returned home, in Step S22, the evaluation system determination unit 82 causes the evaluation system execution unit 83 to execute the passive evaluation system.

Meanwhile, in a case where it is determined in Step S21 that the consumer has not returned home, in Step S23, the evaluation system determination unit 82 determines whether a search application has been activated by the personal terminal 4 or not. The search application is an application for allowing the consumer to search for encountered advertisements.

In a case where it is determined in Step S23 that the search application has been activated, in Step S24, the evaluation system determination unit 82 causes the evaluation system execution unit 83 to execute the active evaluation system.

Meanwhile, in a case where it is determined in Step S23 that the search application has not been activated, in Step S25, the evaluation system determination unit 82 causes the evaluation system execution unit 83 to execute the latent evaluation system. That is, in cases other than a case where the consumer has returned home and a case where the search application has been activated, the latent evaluation system is always executed by the evaluation system execution unit 83.

After the evaluation system to be executed by the evaluation system execution unit 83 is selected in Step S22, Step S24, and Step S25, the processing returns to Step S2 of FIG. 14, and the subsequent processing is performed.

### —Passive Evaluation System

In the passive evaluation system, when the consumer has returned home, an advertisement list application is activated by the personal terminal 4.

FIG. 16 is a diagram illustrating examples of screens displayed on the advertisement list application.

On the advertisement list application, as illustrated on the left side of FIG. 16, a list of encountered advertisements for the day identified on the basis of the daily location information record of the consumer is presented. For example, as a list of encountered advertisements, the titles of advertisements and images of the advertisement presentation vehicles 3 presenting the advertisements arranged in descending order of consumer gaze degree are presented. With the presentation of the list of encountered advertisements arranged in descending order of gaze degree, the consumer can easily find information regarding advertisements of interest.

In the example on the left side of FIG. 16, information regarding an advertisement A placed on the side surface of a truck, an advertisement B placed on the window on the side surface of a taxi, and an advertisement C placed on the rear surface of a vehicle is displayed on the personal terminal 4.

The consumer can select advertisements of interest from the list of encountered advertisements. On the advertisement list application, as illustrated on the right side of FIG. 16, details of the advertisement selected by the consumer are presented. In the example on the right side of FIG. 16, the title of the advertisement is displayed at the top of the screen, and below the title of the advertisement, an advertisement image A1 presented by the advertisement presentation vehicle 3 is displayed.

Below the advertisement image A1, advertisement text is displayed. Below the advertisement text, displayed is information regarding the situation when the consumer has encountered the advertisement A, such as the location and time point at which the consumer has encountered the advertisement A, and an image P1 of the advertisement presentation vehicle 3 that has presented the advertisement A.

At the bottom of the screen, a purchase button B1 and a share button B2 are displayed. The consumer can purchase the advertisement target of the advertisement A by pressing the purchase button B1 and share information regarding the advertisement target on SNS by pressing the share button B2.

The advertisement effectiveness measurement server 5 determines the consumption stage on the basis of whether the purchase button B1 or the share button B2 has been pressed.

With reference to the flowchart of FIG. 17, the processing flow of the passive evaluation system is described.

In Step S41, the communication unit 81 refers to consumer information and vehicle information to acquire the location information record of the consumer and the driving record of the advertisement presentation vehicle 3.

In Step S42, the gaze degree calculation unit 91 determines encountered advertisements on the basis of the location information record of the consumer and the driving record of the advertisement presentation vehicle 3, and the display control unit 92 acquires a list of the encountered advertisements. Further, the gaze degree calculation unit 91 acquires the timing of the encounter between the consumer and the encountered advertisements on the basis of the location information record of the consumer and the driving record of the advertisement presentation vehicle 3.

In Step S43, the gaze degree calculation unit 91 acquires, as information for gaze degree calculation, for example, the location information record of the consumer, the terminal operation record of the consumer, the browsing history of the consumer, and the driving record of the advertisement presentation vehicle 3, by referring to the consumer information and the vehicle information.

In Step S44, the gaze degree calculation unit 91 calculates the gaze degrees of the consumer for the encountered advertisements on the basis of the information for gaze degree calculation.

In Step S45, the display control unit 92 causes the personal terminal 4 to activate the advertisement list application and display the list of encountered advertisements arranged in descending order of gaze degree on the advertisement list application.

In Step S46, the consumption stage determination unit 93 starts monitoring operations performed by the consumer on the advertisement list application.

In Step S47, the consumption stage determination unit 93 determines whether the consumer has taken consumption behavior or not and continues monitoring operations on the advertisement list application until the consumer takes consumption behavior. For example, the consumption stage determination unit 93 determines that the consumer has taken consumption behavior in a case where the purchase button or the share button has been pressed on the advertisement list application.

In a case where it is determined in Step S47 that the consumer has taken consumption behavior, the consumption stage determination unit 93 determines the consumption stage and acquires the consumption timing on the basis of the operation content on the advertisement list application. After that, in Step S48, the advertisement effectiveness measurement unit 94 acquires the difference between the encounter timing and the consumption timing as required consumption time.

In Step S49, the advertisement effectiveness measurement unit 94 calculates an evaluation value on the basis of the gaze degree, the required consumption time, and the consumption stage, and measures the effectiveness of the advertisement on the basis of the evaluation value.

In Step S50, the evaluation system execution unit 83 determines whether to end the execution of the passive evaluation system or not. For example, the evaluation system execution unit 83 determines to end the execution of the passive evaluation system in a case where the consumer has taken consumption behavior on the share stage.

In a case where it is determined in Step S50 not to end the execution of the passive evaluation system, the processing returns to Step S47, and the subsequent processing is performed.

Meanwhile, in a case where it is determined in Step S50 to end the execution of the passive evaluation system, the processing of the passive evaluation system ends.

### —Active Evaluation System

In the active evaluation system, the consumer can search for an advertisement of interest on the search application on the basis of a vague memory such as the color of the vehicle body of the advertisement presentation vehicle 3 or objects appearing in the advertisement.

FIG. 18 is a diagram illustrating examples of screens displayed on the search application.

On the search application, as illustrated on the left side of FIG. 18, a screen for searching for advertisements by specifying various search keys is presented. The search keys include, for example, as illustrated in FIG. 19, the location at which an advertisement has been seen, the time at which an advertisement has been seen, the type of the advertisement presentation vehicle 3, the color of the vehicle body of the advertisement presentation vehicle 3, the content of an advertisement, and adjacent advertisements.

In the example of FIG. 19, as the location at which an advertisement has been seen, place names or locations on a map are specified, and as the time at which an advertisement has been seen, periods with a range, such as morning and afternoon or time points every two hours, are specified. As the type of the advertisement presentation vehicle 3, Kei cars, passenger cars, trucks, or the like are specified, and as the content of an advertisement, the kinds of animals, names of people, or attributes of people appearing in an advertisement image are specified. As the adjacent advertisements, companies that are advertisers of other advertisements presented before and after an advertisement that the consumer wants to search for are specified.

When these search keys are specified to search for an advertisement, as indicated by Arrow #1 of FIG. 18, a list of advertisements that meet the conditions of the search keys among encountered advertisements is presented. For example, as a list of advertisements, the titles of advertisements and images of the advertisement presentation vehicles 3 presenting the advertisements arranged in descending order of consumer gaze degree are presented. A gaze degree for an advertisement that the consumer wants to search for is considered to be high, and hence the list of advertisements arranged in descending order of gaze degree is presented to make it easier for the consumer to find the intended advertisement.

The consumer can select an advertisement, details of which he/she wants to check, from the list of advertisements. On the search application, as indicated by Arrow #2 of FIG. 18, details of the advertisement selected by the consumer are presented. Here, a screen similar to the screen presenting details of advertisements displayed on the advertisement list application is displayed.

The advertisement effectiveness measurement server 5 determines the consumption stage depending on whether the purchase button or the share button has been pressed.

As described above, by allowing consumers to search for advertisements after time has elapsed since they have encountered the advertisements on the basis of ambiguous information such as the color of the vehicle body of the advertisement presentation vehicle 3 that has presented the advertisements and the locations at which the advertisements have been seen, it is possible to prevent the loss of consumption opportunities due to consumers not being able to recall details of advertisements.

With reference to the flowchart of FIG. 20, the processing flow of the active evaluation system is described.

In Step S61, the gaze degree calculation unit 91 receives the search keys input by the consumer.

In Step S62, the gaze degree calculation unit 91 determines encountered advertisements on the basis of the location information record of the consumer and the driving record of the advertisement presentation vehicles 3 and acquires a list of advertisements that match the conditions of the search keys input by the consumer among the encountered advertisements, on the basis of the advertisement information, the vehicle information, and the consumer information. Further, the gaze degree calculation unit 91 acquires the timing of the encounter between the consumer and the encountered advertisements on the basis of the location information record of the consumer and the driving record of the advertisement presentation vehicle 3.

In Step S63, the gaze degree calculation unit 91 acquires information for gaze degree calculation.

In Step S64, the gaze degree calculation unit 91 calculates the gaze degrees of the consumer for the encountered advertisements on the basis of the information for gaze degree calculation.

In Step S65, the display control unit 92 displays the list of encountered advertisements which match the conditions of the search keys and are arranged in descending order of gaze degree on the search application.

In Step S66, the consumption stage determination unit 93 starts monitoring operations performed by the consumer on the search application.

In Step S67, the consumption stage determination unit 93 determines whether the consumer has taken consumption behavior or not and continues monitoring operations on the search application until the consumer takes consumption behavior. For example, the consumption stage determination unit 93 determines that the consumer has taken consumption behavior in a case where the purchase button or the share button has been pressed on the search application.

In a case where it is determined in Step S67 that the consumer has taken consumption behavior, the consumption stage determination unit 93 determines the consumption stage and acquires the consumption timing on the basis of the operation content on the search application. After that, in Step S68, the advertisement effectiveness measurement unit 94 acquires the difference between the encounter timing and the consumption timing as required consumption time.

In Step S69, the advertisement effectiveness measurement unit 94 calculates an evaluation value on the basis of the gaze degree, the required consumption time, and the consumption stage, and measures the effectiveness of the advertisement on the basis of the evaluation value.

In Step S70, the evaluation system execution unit 83 determines whether to end the execution of the active evaluation system or not. For example, the evaluation system execution unit 83 determines to end the execution of the active evaluation system in a case where the consumer has taken consumption behavior on the share stage or has closed the search application.

In a case where it is determined in Step S70 not to end the execution of the active evaluation system, the processing returns to Step S67, and the subsequent processing is performed.

Meanwhile, in a case where it is determined in Step S70 to end the execution of the active evaluation system, the processing of the active evaluation system ends.

### —Latent Evaluation System

In the latent evaluation system, the effectiveness of advertisements is measured on the basis of the location information record, terminal operation record, and browsing history of the consumer. In the latent evaluation system, even in a case where the consumer does not use a predetermined application (advertisement list application or search application) unlike in the passive evaluation system or the active evaluation system, the consumption stage can be determined.

FIG. 21 is a diagram illustrating an example of a determination method for consumption stages in the latent evaluation system.

In the latent evaluation system, as illustrated in the upper left of FIG. 21, it is determined whether the consumer may possibly have seen an advertisement on the basis of the driving record (movement history) of the advertisement presentation vehicle 3 and the location information record (movement history) of the individual consumer. For example, in a case where the location information regarding the advertisement presentation vehicle 3 matches the location information regarding the consumer at a certain time point, it is determined that the consumer may possibly have seen the advertisement.

In a case where the consumer may possibly have seen the advertisement, it is determined that the consumer has taken consumption behavior on the attention stage or the interest stage.

Further, in the latent evaluation system, as illustrated in the upper right of FIG. 21, the nature of websites viewed by the consumer is identified on the basis of the browsing history of the individual consumer. In a case where the site viewed by the consumer is a search site, it is determined that the consumer has taken consumption behavior on the search stage, and in a case where the site viewed by the consumer is an EC site, it is determined that the consumer has taken consumption behavior on the action stage. In a case where the site viewed by the consumer is an SNS site, it is determined that the consumer has taken consumption behavior on the share stage.

Note that, as indicated by the arrow in the lower section of FIG. 21, in the latent evaluation system, the effectiveness of advertisements is determined to be high in the order of attention, interest, search, action, and share stages.

With reference to the flowchart of FIG. 22, the processing flow of the latent evaluation system is described.

In Step S81, the communication unit 81 refers to consumer information to acquire the browsing history and terminal operation record of the consumer.

In Step S82, the consumption stage determination unit 93 determines whether the consumer has taken consumption behavior, on the basis of the browsing history and the terminal operation record, and monitors the browsing history and the terminal operation record until the consumer takes consumption behavior. For example, the consumption stage determination unit 93 determines that the consumer has taken consumption behavior in a case where the consumer has accessed web pages or applications of genres related to consumption, such as search engines, EC sites, or SNS sites.

In a case where it is determined in Step S82 that the consumer has taken consumption behavior, the consumption stage determination unit 93 determines the consumption stage and acquires the consumption timing on the basis of the browsing history and the terminal operation record. After that, in Step S83, the gaze degree calculation unit 91 acquires information for gaze degree calculation and calculates a gaze degree for the advertisement for the advertisement target, for which consumption behavior may be taken, on the basis of the information for gaze degree calculation. Further, the gaze degree calculation unit 91 acquires the timing of the encounter between the consumer and the advertisement on the basis of the location information record of the consumer and the driving record of the advertisement presentation vehicle 3.

In Step S84, the advertisement effectiveness measurement unit 94 acquires the difference between the encounter timing and the consumption timing as required consumption time.

In Step S85, the advertisement effectiveness measurement unit 94 calculates an evaluation value on the basis of the gaze degree, the required consumption time, and the consumption stage, and measures the effectiveness of the advertisement on the basis of the evaluation value.

In Step S86, the evaluation system execution unit 83 determines whether to end the execution of the latent evaluation system or not. For example, the evaluation system execution unit 83 determines to end the execution of the latent evaluation system in a case where the consumer has taken consumption behavior on the share stage.

In a case where it is determined in Step S86 not to end the execution of the latent evaluation system, the processing returns to Step S82, and the subsequent processing is performed. Meanwhile, in a case where it is determined in Step S86 to end the execution of the latent evaluation system, the processing of the latent evaluation system ends.

As described above, in the advertisement effectiveness measurement server 5 of the present technology, the effectiveness of advertisements presented by the advertisement presentation vehicle 3 is measured on the basis of gaze degrees, encounter timing, consumption timing, and consumption stages.

In the advertisement effectiveness measurement server 5, the gaze degree is calculated on the basis of the driving record of the advertisement presentation vehicle 3, the location information record of the consumer, the terminal operation record of the consumer, and the like. The advertisement effectiveness measurement server 5 can determine which advertisement the consumer has been influenced by to take consumption behavior, on the basis of gaze degrees.

The advertisement effectiveness measurement server 5 changes the evaluation value depending on the difference between the predicted consumption time set for each advertisement and the required consumption time from encounter timing to consumption timing, thereby being capable of determining whether the consumer has been influenced by the advertisements to accurately measure the effectiveness of the advertisements. Since the predicted consumption time is set for each category of advertisement targets, it is possible to accurately measure the effectiveness of various advertisements that take different amounts of time to induce consumption behavior.

The advertisement effectiveness measurement server 5 provides advertisement list applications or search applications and monitors a browsing history and terminal operation records, thereby being capable of determining the consumption behavior of consumers step by step, rather than determining only the purchase of products as the consumption behavior of consumers, for example.

### 3. Application Examples

### —Example in Which Advertisements Are Optimized on Basis of Effectiveness of Advertisements

It is also possible for the advertisement evaluation system to analyze, after measuring the effectiveness of advertisements, the attributes of advertisements that have been highly effective, as well as the presentation conditions of the advertisements, such as the driving location, driving velocity, and type of the advertisement presentation vehicle 3, and to utilize the analysis results. When advertisements to be presented are selected depending on the analysis results, it is possible to enhance the effectiveness of the advertisements.

FIG. 23 is a diagram illustrating an example in which advertisement effectiveness analysis results are utilized.

For example, suitable time points, locations, velocities, and the like for presenting an advertisement are analyzed on the basis of an evaluation value for measuring the effectiveness of the advertisement and the driving record of the advertisement presentation vehicle 3 that has presented the advertisement. As illustrated in FIG. 23, the advertisement presentation vehicle 3 selects and presents the optimal advertisement on the basis of the analysis result, depending on the current time point, the location, the velocity, and the like.

It is also possible for the advertisement presentation vehicle 3 to recognize the attributes of surrounding people, such as gender and age, using cameras or the like, and to select and present the optimal advertisement depending on the attributes.

When effective advertisements are selected and presented to consumers, the provider of the advertisement presentation vehicle 3 can increase the sales of advertisement targets and obtain incentives corresponding to the sales, for example.

Further, the advertiser can obtain information regarding the presentation conditions of highly effective advertisements on the basis of analysis results and grasp what kind of the advertisement presentation vehicle 3 is effective for presenting advertisements. Even in areas where the stimulation of consumption behavior by advertisements is insufficient, when advertisements are presented under highly effective presentation conditions, it is possible to improve the effectiveness of the advertisements across a wide area.

FIG. 24 is a block diagram illustrating a configuration example of the advertisement effectiveness measurement server 5 configured to analyze the effectiveness of advertisements. In FIG. 24, the same components as the components of FIG. 8 are denoted by the same reference signs. Redundant descriptions are appropriately omitted.

The configuration of the advertisement effectiveness measurement server 5 illustrated in FIG. 24 is different from the configuration of the advertisement effectiveness measurement server 5 of FIG. 8 in including an advertisement effectiveness analysis unit 101.

On the basis of evaluation values calculated by the advertisement effectiveness measurement unit 94 and the attributes and presentation conditions of advertisements, the advertisement effectiveness analysis unit 101 analyzes the attributes and presentation conditions of advertisements that achieve high effectiveness of advertisements. The attributes and presentation conditions of advertisements are acquired by referring to advertisement information, vehicle information, and consumer information.

FIG. 25 is a block diagram illustrating a configuration example of the advertiser terminal 1 utilizing advertisement effectiveness analysis results. In FIG. 25, the same components as the components of FIG. 2 are denoted by the same reference signs. Redundant descriptions are appropriately omitted.

The configuration of the advertiser terminal 1 illustrated in FIG. 25 is different from the configuration of the advertiser terminal 1 of FIG. 2 in including an advertisement content optimization unit 111.

The advertisement content optimization unit 111 optimizes, for example, the lengths or content of advertisements on the basis of the results of analysis by the advertisement effectiveness analysis unit 101.

The advertisement information definition unit 21 records, for example, the content of advertisements optimized by the advertisement content optimization unit 111 in the advertisement information.

FIG. 26 is a block diagram illustrating a configuration example of the advertisement presentation vehicle 3 utilizing advertisement effectiveness analysis results. In FIG. 26, the same components as the components of FIG. 4 are denoted by the same reference signs. Redundant descriptions are appropriately omitted.

The configuration of the advertisement presentation vehicle 3 illustrated in FIG. 26 is different from the configuration of the advertisement presentation vehicle 3 of FIG. 4 in including a presentation method optimization unit 121.

The presentation method optimization unit 121 optimizes advertisements to be presented or optimizes the positions on the advertisement presentation vehicle 3 at which advertisements are presented, on the basis of the results of analysis by the advertisement effectiveness analysis unit 101, depending on driving locations or driving velocities. For example, in a case where the multiple advertisement presentation units 44 are provided on the advertisement presentation vehicle 3, the presentation method optimization unit 121 controls the presentation control unit 43 to present advertisements from the advertisement presentation units 44 provided at highly effective positions.

As described above, it is possible to create more effective advertisements or determine more effective advertisement presentation methods on the basis of advertisement effectiveness measurement results.

### —Example in Which Incentives Depending on Consumption Stages Are Given and Received

Other than the case where the advertising agency presents advertisements on the vehicles owned by itself, it is conceivable that the advertising agency outsources, to vehicle providers such as taxi companies, car rental companies, or individuals, the presentation of advertisements on the vehicles owned by the vehicle providers. These vehicle providers are rewarded.

In this case, the advertising agency can determine rewards to be received by the vehicle providers depending on consumption stages.

FIG. 27 is a diagram illustrating examples of rewards depending on consumption stages.

In a case where the consumer has taken consumption behavior, the vehicle provider of the advertisement presentation vehicle 3 that has presented the advertisement for the advertisement target, for which consumption behavior may be taken, to the consumer before the consumer has taken consumption behavior gets a reward that increases as the consumption stage progresses as illustrated in FIG. 27. The consumption stage progresses in the order of search, action, and share.

FIG. 28 is a block diagram illustrating a configuration example of the advertising agency server 2 configured to determine rewards depending on consumption stages. In FIG. 28, the same components as the components of FIG. 2 are denoted by the same reference signs. Redundant descriptions are appropriately omitted.

The configuration of the advertising agency server 2 illustrated in FIG. 28 is different from the configuration of the advertising agency server 2 of FIG. 2 in including a reward determination unit 151.

The reward determination unit 151 determines a reward for the provider of the advertisement presentation vehicle 3 on the basis of the result of consumption stage determination by the consumption stage determination unit 93 of the advertisement effectiveness measurement server 5.

FIG. 29 is a block diagram illustrating a configuration example of the advertisement presentation vehicle 3 configured to receive rewards depending on consumption stages. In FIG. 29, the same components as the components of FIG. 4 are denoted by the same reference signs. Redundant descriptions are appropriately omitted.

The configuration of the advertisement presentation vehicle 3 illustrated in FIG. 29 is different from the configuration of the advertisement presentation vehicle 3 of FIG. 4 in including a reward giving/receiving unit 161.

The reward giving/receiving unit 161 receives rewards from the advertising agency on the basis of reward information indicating the amount of reward determined by the reward determination unit 151.

As described above, depending on the stage of consumption behavior taken by the consumer who has seen an advertisement, the advertising agency can determine a reward to be received by the provider of the advertisement presentation vehicle 3 that has presented the advertisement.

### —Example in Which Advertisements Are Optimized on Basis of Past Consumption Behavior That Consumer Has Taken

Regarding advertisements for which the consumer has not taken consumption behavior on the share stage, the advertisement evaluation system can also analyze the causes why the consumer has not taken consumption behavior on the share stage and provide feedback. It is possible to create more effective advertisements or determine more effective advertisement presentation methods depending on the analysis results.

FIG. 30 is a block diagram illustrating a configuration example of the advertisement effectiveness measurement server 5 configured to analyze causes for the consumption stages. In FIG. 30, the same components as the components of FIG. 8 are denoted by the same reference signs. Redundant descriptions are appropriately omitted.

The configuration of the advertisement effectiveness measurement server 5 illustrated in FIG. 30 is different from the configuration of the advertisement effectiveness measurement server 5 of FIG. 8 in including a cause analysis unit 201. Further, the configuration of the advertisement effectiveness measurement server 5 illustrated in FIG. 30 is different from the configuration of the advertisement effectiveness measurement server 5 of FIG. 8 in that consumer information is supplied from the communication unit 81 to the advertisement effectiveness measurement unit 94.

The advertisement effectiveness measurement unit 94 supplies the results of consumption stage determination by the consumption stage determination unit 93 and the consumer information supplied from the communication unit 81 to the cause analysis unit 201.

The cause analysis unit 201 analyzes the causes for the consumption stage determined by the consumption stage determination unit 93 on the basis of the consumer information supplied from the advertisement effectiveness measurement unit 94. Specifically, in a case where the consumer has not taken consumption behavior on the share stage, the cause analysis unit 201 analyzes the causes why the consumer has not taken consumption behavior on the share stage, on the basis of the browsing history and terminal operation record recorded in the consumer information.

For example, as illustrated in FIG. 31, in a case where the consumer has taken consumption behavior on the search stage and viewed a price comparison site, the cause analysis unit 201 analyzes that the reason why the consumer has not taken consumption behavior on the action and share stages is that the price of the advertisement target is high.

In a case where the consumer has taken consumption behavior on the search stage and viewed a review site, the cause analysis unit 201 analyzes that the reason why the consumer has not taken consumption behavior on the action and share stages is that the reviews for the advertisement target are negative.

In a case where the consumer has taken consumption behavior on the search stage and viewed a site about similar products to the advertisement target, the cause analysis unit 201 analyzes that the reason why the consumer has not taken consumption behavior on the action and share stages is that a product from another company has been found more attractive than the advertisement target in comparison.

In a case where the consumer has taken consumption behavior on the action stage but is not an active user of SNS, the cause analysis unit 201 analyzes that the reason why the consumer has not taken consumption behavior on the share stage is that the attributes of the consumer are not suitable.

In a case where the consumer has taken consumption behavior on the action stage and is an active user of SNS, but has not shared information regarding the advertisement target on SNS, the cause analysis unit 201 analyzes that the reason why the consumer has not taken consumption behavior on the share stage is that the appearance of the product, which is an advertisement target, is poor.

FIG. 32 is a block diagram illustrating a configuration example of the advertiser terminal 1 utilizing consumption stage analysis results. In FIG. 32, the same components as the components of FIG. 2 are denoted by the same reference signs. Redundant descriptions are appropriately omitted.

The configuration of the advertiser terminal 1 illustrated in FIG. 32 is different from the configuration of the advertiser terminal 1 of FIG. 2 in including an advertisement content optimization unit 211.

The advertisement content optimization unit 211 optimizes, for example, the lengths or content of advertisements, and the prices of the advertisement targets, on the basis of the results of analysis by the cause analysis unit 201.

The advertisement information definition unit 21 records, for example, the content of advertisements optimized by the advertisement content optimization unit 211 in the advertisement information.

Note that, in the advertisement presentation vehicle 3, advertisements to be presented may be optimized, or the positions on the advertisement presentation vehicle 3 at which advertisements are presented may also be optimized, on the basis of the results of analysis by the cause analysis unit 201, depending on driving locations or driving velocities.

As described above, it is possible to create more effective advertisements or determine more effective advertisement presentation methods on the basis of causes for the consumption stages.

Example in Which Advertisements Are Optimized Depending on Consumer Transportation Methods The advertisement presentation vehicle 3 can also change advertisements to be presented depending on consumer transportation methods, such as walking, driving, and cycling.

FIG. 33 depicts diagrams illustrating examples of advertisements depending on consumer transportation methods.

In a case where a consumer C1 is moving on foot, as illustrated in A of FIG. 33, the advertisement presentation vehicle 3 presents a regular advertisement.

In a case where a consumer C2 is traveling by car, since the consumer C2 can carry heavy objects back home in the car, as illustrated in B of FIG. 33, the advertisement presentation vehicle 3 presents an advertisement for a home appliance or an advertisement for a discount for a bulk purchase.

In this way, the advertisement presentation vehicle 3 estimates the capacity that the consumers can carry back home, on the basis of the consumer transportation methods, and presents advertisements suitable for the capacity, thereby being capable of increasing the probability of the purchase of the advertisement targets.

FIG. 34 is a block diagram illustrating a configuration example of the advertisement effectiveness measurement server 5 configured to determine consumer transportation methods. In FIG. 34, the same components as the components of FIG. 8 are denoted by the same reference signs. Redundant descriptions are appropriately omitted.

The configuration of the advertisement effectiveness measurement server 5 illustrated in FIG. 34 is different from the configuration of the advertisement effectiveness measurement server 5 of FIG. 8 in including a consumer transportation method determination unit 251.

The consumer transportation method determination unit 251 calculates the moving velocity of consumers around the advertisement presentation vehicle 3 on the basis of the moving information records of the consumers recorded in the consumer information and estimates the transportation methods on the basis of the moving velocity.

FIG. 35 is a block diagram illustrating a configuration example of the advertisement presentation vehicle 3 configured to change advertisements depending on consumer transportation methods. In FIG. 35, the same components as the components of FIG. 4 are denoted by the same reference signs. Redundant descriptions are appropriately omitted.

The configuration of the advertisement presentation vehicle 3 illustrated in FIG. 35 is different from the configuration of the advertisement presentation vehicle 3 of FIG. 4 in including a presentation method optimization unit 261.

The presentation method optimization unit 261 optimizes advertisements to be presented or optimizes the positions on the advertisement presentation vehicle 3 at which advertisements are presented, depending on the consumer transportation methods estimated by the consumer transportation method determination unit 251. Note that the consumer transportation method may be estimated on the basis of images captured by cameras provided directly on the advertisement presentation vehicle 3.

As described above, the advertisement presentation vehicle 3 can present advertisements for advertisement targets for which the consumers take consumption behavior with high possibility, on the basis of the consumer transportation methods.

### —Example in Which Advertisements Are Optimized Depending on Map Information Regarding Surroundings of Consumers

FIG. 36 depicts diagrams illustrating examples of advertisements depending on map information regarding the surroundings of consumers.

A consumer traveling by car cannot operate the car navigation apparatus while the car is in motion. Thus, in a case where there are available parking locations such as parking lots around the consumer, as illustrated in A of FIG. 36, the advertisement presentation vehicle 3 presents advertisements for places that need to be set as destinations on the car navigation apparatus, such as restaurants or shopping malls.

In a case where there are no parking lots or the like around the consumer, as illustrated in B of FIG. 36, the advertisement presentation vehicle 3 presents advertisements for advertisement targets that can be purchased on EC sites or advertisement targets that can be purchased later.

FIG. 37 is a block diagram illustrating a configuration example of the advertisement presentation vehicle 3 configured to change advertisements depending on map information regarding the surroundings of consumers. In FIG. 37, the same components as the components of FIG. 4 are denoted by the same reference signs. Redundant descriptions are appropriately omitted.

The configuration of the advertisement presentation vehicle 3 illustrated in FIG. 37 is different from the configuration of the advertisement presentation vehicle 3 of FIG. 4 in including a surrounding information acquisition unit 301 and a presentation method optimization unit 302.

The surrounding information acquisition unit 301 acquires map information regarding the surroundings of the advertisement presentation vehicle 3 and supplies the map information to the presentation method optimization unit 302.

The presentation method optimization unit 302 determines whether a consumer around the advertisement presentation vehicle 3 is traveling by car or the like, on the basis of the result of estimation by the consumer transportation method determination unit 251 of the advertisement effectiveness measurement server 5. In a case where the consumer is traveling by car, the presentation method optimization unit 302 determines whether there are available parking locations around the advertisement presentation vehicle 3, on the basis of the map information supplied from the surrounding information acquisition unit 301.

Depending on the presence or absence of available parking locations, the presentation method optimization unit 302 optimizes advertisements to be presented. Note that the consumer transportation method may be estimated on the basis of images captured by cameras provided directly on the advertisement presentation vehicle 3.

As described above, it is possible to present advertisements for advertisement targets for which the consumer takes consumption behavior with high possibility, on the basis of map information regarding the surroundings of the consumer (advertisement presentation vehicle 3).

### —Example of Outdoor Advertisements

It is also possible to apply the present technology to the measurement of the effectiveness of outdoor advertisements presented on advertising media other than the advertisement presentation vehicle 3, such as outdoor advertising media.

FIG. 38 is a block diagram illustrating a configuration example of an outdoor advertising medium 351.

The outdoor advertising medium 351 includes an information presentation medium placed outdoors or in a public space, such as a digital signage or an outdoor billboard. As illustrated in FIG. 38, the outdoor advertising medium 351 includes a communication unit 361, an advertisement information accumulation unit 362, a presentation control unit 363, an advertisement presentation unit 364, and an installation information definition unit 365.

The communication unit 361 communicates with other apparatuses such as the advertising agency server 2 and the advertisement effectiveness measurement server 5 via the network. Specifically, the communication unit 361 receives the advertisement information transmitted from the advertising agency server 2 and supplies the advertisement information to the advertisement information accumulation unit 362. Further, the communication unit 361 transmits the installation information supplied from the installation information definition unit 365 to the advertisement effectiveness measurement server 5 together with the advertisement information held in the advertisement information accumulation unit 362.

The advertisement information accumulation unit 362 holds the advertisement information supplied from the communication unit 361.

The presentation control unit 363 acquires advertisement information from the advertisement information accumulation unit 362 and acquires advertisement images or advertisement audio corresponding to the advertisement information from the advertising agency server 2 via the network, for example. The presentation control unit 363 supplies the advertisement images or the advertisement audio to the advertisement presentation unit 364 and causes the advertisement presentation unit 364 to display the advertisement images or output the advertisement audio.

The presentation control unit 363 supplies information indicating the advertisements presented by the advertisement presentation unit 364 and the time at which the advertisements have been presented to the installation information definition unit 365.

The advertisement presentation unit 364 includes a display or a speaker. The advertisement presentation unit 364 presents advertisements to consumers under the control of the presentation control unit 363. Note that it is also possible to put up a poster or the like having printed thereon an advertisement image to the outdoor advertising medium 351, as the advertisement presentation unit 364.

The installation information definition unit 365 records the information supplied from the presentation control unit 363 as installation information, together with information regarding the outdoor advertising medium 351. As installation information, for example, the type, color, installation position, advertisement placement record, and advertisement placement position of the outdoor advertising medium 351 are defined. In the installation information definition unit 365, the installation position of the outdoor advertising medium 351 is set in advance.

The installation information definition unit 365 supplies the defined installation information to the communication unit 361.

Note that, in a case where the outdoor advertising medium 351 includes a digital signage, the processing of the communication unit 361 and the advertisement information accumulation unit 362 is executed by a processor and memory built in the digital signage, for example. In a case where the outdoor advertising medium 351 includes an analog medium such as an outdoor billboard, the processing of the communication unit 361 and the advertisement information accumulation unit 362 is executed by computers or servers prepared separately from the outdoor billboard.

The advertisement effectiveness measurement server 5 acquires a gaze degree for an advertisement and encounter timing on the basis of the installation information acquired from the outdoor advertising medium 351. Here, the advertisement effectiveness measurement server 5 calculates the gaze degree assuming the movement velocity of the outdoor advertising medium 351 as 0. On the basis of the gaze degree and other information, the advertisement effectiveness measurement server 5 can measure the effectiveness of the advertisement presented by the outdoor advertising medium 351.

### <Computer>

The series of processing described above can be executed by hardware or software. In a case where the series of processing is executed by software, a program configuring the software is installed on a computer incorporated in dedicated hardware, a general-purpose personal computer, or the like from a program recording medium.

FIG. 39 is a block diagram illustrating a configuration example of the hardware of a computer configured to execute the series of processing described above by the program. Parts of the configurations of the advertiser terminal 1, the advertising agency server 2, the advertisement presentation vehicle 3, the personal terminal 4, the advertisement effectiveness measurement server 5, and the outdoor advertising medium 351 include PCs having a configuration similar to the configuration illustrated in FIG. 39, for example.

A CPU (Central Processing Unit) 501, a ROM (Read Only Memory) 502, and a RAM (Random Access Memory) 503 are connected to each other through a bus 504.

An input/output interface 505 is further connected to the bus 504. The input/output interface 505 is connected to an input unit 506 including a keyboard, a mouse, or the like, and an output unit 507 including a display, a speaker, or the like. Further, the input/output interface 505 is connected to a storage unit 508 including a hard disk, a non-volatile memory, or the like, a communication unit 509 including a network interface or the like, and a drive 510 configured to drive a removable medium 511.

In the computer configured as described above, for example, the CPU 501 loads the program stored in the storage unit 508 into the RAM 503 through the input/output interface 505 and the bus 504 and executes the program to perform the series of processing described above.

The program to be executed by the CPU 501 is provided by being recorded on the removable medium 511, for example, or via a wired or wireless transmission medium, such as a local area network, the Internet, or digital broadcasting, and is installed on the storage unit 508.

The program to be executed by the computer may be a program whose processing is performed chronologically in the order described herein or in parallel. Alternatively, the program may be a program whose processing is performed at required timing such as when the program is called.

### <Others>

Note that “system” herein means a set of multiple components (apparatuses, modules (parts), or the like), and it does not matter whether all the components are in the same housing or not. Thus, multiple apparatuses accommodated in separate housings and connected to each other via a network, and a single apparatus including multiple modules accommodated in a single housing are both systems.

Note that the effects described herein are merely exemplary and not limited, and there may be other effects.

Embodiments of the present technology are not limited to the embodiment described above, and various modifications can be made without departing from the gist of the present technology.

For example, the present technology can take a configuration of cloud computing in which a single function is shared and collaboratively processed by multiple apparatuses via a network.

Further, each step described with the flowcharts described above can be executed by a single apparatus or shared and executed by multiple apparatuses.

Moreover, in a case where multiple pieces of processing are included in a single step, the multiple pieces of processing included in the single step can be executed by a single apparatus or shared and executed by multiple apparatuses.

### <Examples of Combinations of Configurations>

The present technology can also take the following configurations.

(1)

An information processing apparatus including:
an effectiveness measurement unit configured to measure effectiveness of an advertisement on the basis of encounter timing at which a user has encountered the advertisement and consumption timing at which the user has taken consumption behavior for an advertisement target of the advertisement.
   (2)

The information processing apparatus according to (1) above, in which the effectiveness measurement unit measures the effectiveness of the advertisement on the basis of an evaluation value calculated using a weight corresponding to required consumption time from the encounter timing to the consumption timing.

(3)

The information processing apparatus according to (2) above, in which the effectiveness measurement unit calculates the evaluation value using the weight and an evaluation formula based on at least any of a gaze degree of the user for the advertisement and a stage of the consumption behavior.

(4)

The information processing apparatus according to (2) or (3) above, in which the weight is a value corresponding to a difference between the required consumption time and predicted consumption time required from the encounter timing to the consumption timing.

(5)

The information processing apparatus according to (4) above, in which the predicted consumption time is defined depending on a category of the advertisement target.

(6)

The information processing apparatus according to (4) or (5) above, further including:
an update unit configured to update the predicted consumption time on the basis of the required consumption time.
   (7)

The information processing apparatus according to any one of (3) to (6) above, in which the gaze degree is calculated on the basis of at least any of a history of location information regarding an advertising medium configured to present the advertisement to the user, a history of location information regarding the user, and a history of content of an operation performed by the user on a terminal used by the user.

(8)

The information processing apparatus according to (7) above, in which the gaze degree is calculated on the basis of at least any of the following pieces of information regarding the user and the advertisement when they have encountered each other, which are acquired on the basis of the history of the location information regarding the advertising medium and the history of the location information regarding the user: a relative position of the advertising medium to the user, a relative velocity of the advertising medium to the user, directions of travel of the user and a vehicle provided with the advertising medium, and a lane on which the vehicle travels, as well as the following pieces of information regarding the user and the advertisement when they have encountered each other, which are acquired on the basis of the history of the content of the operation performed by the user: operation time of the user and an application that the terminal has been running.

(9)

The information processing apparatus according to any one of (3) to (8) above, in which the stage of the consumption behavior includes, by the user, searching for the advertisement target, purchasing the advertisement target, and disseminating information regarding the advertisement target.

(10)

The information processing apparatus according to any one of (3) to (9) above, further including:
a display control unit configured to cause a terminal used by the user to display a list of the advertisements encountered by the user.
   (11)

The information processing apparatus according to (10) above, in which the consumption timing is acquired on the basis of content of an operation performed by the user on the list of the advertisements encountered by the user.

(12)

The information processing apparatus according to (10) or (11) above, in which the display control unit causes the terminal to display the list of the advertisements arranged in descending order of the gaze degree.

(13)

The information processing apparatus according to any one of (10) to (12) above, in which the display control unit causes the terminal to display the list of the advertisements that meet a condition specified by the user among the advertisements encountered by the user.

(14)

The information processing apparatus according to (13) above, in which the condition specified by the user includes at least any of a location at which the advertisement has been encountered, time at which the advertisement has been encountered, a type of a vehicle provided with an advertising medium configured to present the advertisement to the user, a color of the vehicle, content of the advertisement, and other advertisements presented before and after the advertisement.

(15)

The information processing apparatus according to any one of (1) to (14) above, in which the effectiveness measurement unit acquires the consumption timing on the basis of content of an operation performed by the user on a terminal used by the user.

(16)

The information processing apparatus according to any one of (1) to (15) above, in which the encounter timing is acquired on the basis of a history of location information regarding the user and a history of location information regarding an advertising medium configured to present the advertisement to the user.

(17)

An information processing method including:
calculating, by an information processing apparatus, an evaluation value of an advertisement on the basis of encounter timing at which a user has encountered the advertisement and consumption timing at which the user has taken consumption behavior for an advertisement target of the advertisement.
   (18)

A computer-readable recording medium having recorded thereon a program for executing processing of:
calculating an evaluation value of an advertisement on the basis of encounter timing at which a user has encountered the advertisement and consumption timing at which the user has taken consumption behavior for an advertisement target of the advertisement.

### REFERENCE SIGNS LIST

1: Advertiser terminal
2: Advertising agency server
3: Advertisement presentation vehicle
4: Personal terminal
5: Advertisement effectiveness measurement server
21: Advertisement information definition unit
31: Advertisement information accumulation unit
32: Communication unit
41: Communication unit
42: Advertisement information accumulation unit
43: Presentation control unit
44: Advertisement presentation unit
45: Driving information acquisition unit
46: Vehicle information definition unit
61: Input unit
62: Presentation control unit
63: Display unit
64: Location information acquisition unit
65: Consumer information definition unit
66: Communication unit
81: Communication unit
82: Evaluation system determination unit
83: Evaluation system execution unit
84: Advertisement information update unit
91: Gaze degree calculation unit
92: Display control unit
93: Consumption stage determination unit
94: Advertisement effectiveness measurement unit
95: Determination method storage unit
101: Advertisement effectiveness analysis unit
111: Advertisement content optimization unit
121: Presentation method optimization unit
151: Reward determination unit
161: Reward giving/receiving unit
201: Cause analysis unit
211: Advertisement content optimization unit
251: Consumer transportation method determination unit
261: Presentation method optimization unit
301: Surrounding information acquisition unit
302: Presentation method optimization unit
361: Communication unit
362: Advertisement information accumulation unit
363: Presentation control unit
364: Advertisement presentation unit
365: Installation information definition unit

1. An information processing apparatus comprising:
an effectiveness measurement unit configured to measure effectiveness of an advertisement on a basis of encounter timing at which a user has encountered the advertisement and consumption timing at which the user has taken consumption behavior for an advertisement target of the advertisement.

2. The information processing apparatus according to claim 1, wherein the effectiveness measurement unit measures the effectiveness of the advertisement on a basis of an evaluation value calculated using a weight corresponding to required consumption time from the encounter timing to the consumption timing.

3. The information processing apparatus according to claim 2, wherein the effectiveness measurement unit calculates the evaluation value using the weight and an evaluation formula based on at least any of a gaze degree of the user for the advertisement and a stage of the consumption behavior.

4. The information processing apparatus according to claim 2, wherein the weight is a value corresponding to a difference between the required consumption time and predicted consumption time required from the encounter timing to the consumption timing.

5. The information processing apparatus according to claim 4, wherein the predicted consumption time is defined depending on a category of the advertisement target.

6. The information processing apparatus according to claim 4, further comprising:
an update unit configured to update the predicted consumption time on a basis of the required consumption time.

7. The information processing apparatus according to claim 3, wherein the gaze degree is calculated on a basis of at least any of a history of location information regarding an advertising medium configured to present the advertisement to the user, a history of location information regarding the user, and a history of content of an operation performed by the user on a terminal used by the user.

8. The information processing apparatus according to claim 7, wherein the gaze degree is calculated on a basis of at least any of the following pieces of information regarding the user and the advertisement when they have encountered each other, which are acquired on a basis of the history of the location information regarding the advertising medium and the history of the location information regarding the user: a relative position of the advertising medium to the user, a relative velocity of the advertising medium to the user, directions of travel of the user and a vehicle provided with the advertising medium, and a lane on which the vehicle travels, as well as the following pieces of information regarding the user and the advertisement when they have encountered each other, which are acquired on a basis of the history of the content of the operation performed by the user: operation time of the user and an application that the terminal has been running.

9. The information processing apparatus according to claim 3, wherein the stage of the consumption behavior includes, by the user, searching for the advertisement target, purchasing the advertisement target, and disseminating information regarding the advertisement target.

10. The information processing apparatus according to claim 3, further comprising:
a display control unit configured to cause a terminal used by the user to display a list of the advertisements encountered by the user.

11. The information processing apparatus according to claim 10, wherein the consumption timing is acquired on a basis of content of an operation performed by the user on the list of the advertisements encountered by the user.

12. The information processing apparatus according to claim 10, wherein the display control unit causes the terminal to display the list of the advertisements arranged in descending order of the gaze degree.

13. The information processing apparatus according to claim 10, wherein the display control unit causes the terminal to display the list of the advertisements that meet a condition specified by the user among the advertisements encountered by the user.

14. The information processing apparatus according to claim 13, wherein the condition specified by the user includes at least any of a location at which the advertisement has been encountered, time at which the advertisement has been encountered, a type of a vehicle provided with an advertising medium configured to present the advertisement to the user, a color of the vehicle, content of the advertisement, and other advertisements presented before and after the advertisement.

15. The information processing apparatus according to claim 1, wherein the effectiveness measurement unit acquires the consumption timing on a basis of content of an operation performed by the user on a terminal used by the user.

16. The information processing apparatus according to claim 1, wherein the encounter timing is acquired on a basis of a history of location information regarding the user and a history of location information regarding an advertising medium configured to present the advertisement to the user.

17. An information processing method comprising:
calculating, by an information processing apparatus, an evaluation value of an advertisement on a basis of encounter timing at which a user has encountered the advertisement and consumption timing at which the user has taken consumption behavior for an advertisement target of the advertisement.

18. A computer-readable recording medium having recorded thereon a program for executing processing of:
calculating an evaluation value of an advertisement on a basis of encounter timing at which a user has encountered the advertisement and consumption timing at which the user has taken consumption behavior for an advertisement target of the advertisement.
